(19) United States
(12) Patent Application Publication
(10) Pub. No.: US 2026/0289250 A1
(43) Pub. Date: Sep. 24, 2026

(54) GENERATIVE ARTIFICIAL INTELLIGENCE (AI)-BASED METHODS AND SYSTEMS FOR PROCESSING REGULATORY DATA AND POWER GRID INTERCONNECTIONS

(71) Applicant: Vellex Computing, Inc., San Luis Obispo, CA (US)

(72) Inventors: Vikas Srivastava, Delhi (IN); Sachin Khoja, Ghaziabad (IN); Ajay Jain, Delhi (IN); Palak Jain, San Francisco, CA (US); Jason Poon, San Luis Obispo, CA (US)

(21) Appl. No.: 19/452,239

(22) Filed: Jan. 17, 2026

Related U.S. Application Data
(60) Provisional application No. 63/746,849, filed on Jan. 17, 2025.
(60) Provisional application No. 63/811,594, filed on May 24, 2025.

(51) Int. Cl. G06N 3/0475; G06N 3/042

(52) U.S. Cl. CPC G06N 3/0475; G06N 3/042

(57) ABSTRACT

Generative Artificial Intelligence (AI)-based methods and systems for processing regulatory data and power grid interconnections are disclosed. The method includes receiving user query corresponding to energy management system. Further, the method includes extracting query data from received user query and generating sub-queries using Generative AI models. Furthermore, the method includes obtaining first candidate information responsive to user query and generated sub-queries. Additionally, the method includes generating graphical representation of user query as second candidate information and third candidate information responsive to user query and sub-queries. Additionally, the method includes aggregating first candidate information, second candidate information, and third candidate information into consolidated context-dataset. Further, the method includes analyzing consolidated context-dataset with interconnection attributes and determining interconnection-specific summary. Additionally, the method includes generating refined context data using Gen AI models and Generative AI response to user query. Furthermore, the method includes outputting Generative AI response on user interface of user device.

### CROSS-REFERENCE TO RELATED APPLICATIONS

This application claims the benefit of the earlier-filed provisional applications 63/746,849, filed on Jan. 17, 2025, entitled SYSTEMS, METHODS, AND DEVICES FOR AUTOMATING HIGH FIDELITY RESPONSES TO QUERIES VIA ANALYZING AND ENRICHING UTILITY TARIFF DOCUMENTS THEREOF” and 63/811,594 filed on May 24, 2025, entitled “AI AGENT-ENABLED SOFTWARE ARCHITECTURE FOR STREAMLINED POWER GRID INTERCONNECTION” the contents of which are incorporated herein by reference.

### TECHNICAL FIELD

This patent application is directed to data processing systems and, more specifically, to generative Artificial Intelligence (AI)-based methods and systems for processing regulatory data and power grid interconnections.

### BACKGROUND

Generally, utility tariffs establish rules, rates, and regulatory requirements providing for pricing, access, and operational processes for utilities. The utilities include, such as, for example, but not limited to, electricity, natural gas, water, and communication infrastructure. Further, the utility tariffs include a wide range of factors. The wide range of factors include, such as, for example, but not limited to, taxes, incentives, infrastructure maintenance, generation sources, temporal usage patterns, and multi-tiered regulatory oversight. Due to dynamic nature of utility markets and regulatory frameworks, particularly in an electrical power sector, utility tariff documents are frequently updated, amended, and/or reinterpreted. Further, amendments to the utility tariff documents makes an efficient navigation and a compliance with applicable requirements increasingly difficult for a stakeholder.

Typically, managing tariff and rate structure complexity across a plurality of geographies, utility types, and time periods presents a significant operational challenge for asset developers, independent power producers, load-serving entities, and utility participants. Power grid interconnection processes typically involve multiple governing entities and require satisfaction of numerous procedural steps, eligibility rules, and compliance conditions. Existing interconnection and rate structure evaluation processes rely on fragmented document repositories, manual interpretation of evolving regulatory texts, and static rule-based workflows or predefined decision trees that are manually maintained. Such approaches lack the ability to reason over cross-document dependencies, temporal revisions, and jurisdiction-specific constraints, resulting in inconsistent determinations, increased human intervention, and prolonged application processing timelines.

Further, a set of regulatory rules and a set of interconnection requirements are typically published in a lengthy and unstructured textual document. The lengthy and unstructured textual document may be hosted on at least one of a utility website and/or a regulatory website. Furthermore, a change to the set of regulatory rules are often poorly communicated, inconsistently documented, and/or dispersed across a plurality of sources. As a result, an interconnection applicant frequently encounters difficulty in identifying a current eligibility criteria, an applicable rate structure, and/or a procedural obligation. Further, a lack of transparency in the current eligibility criteria, the applicable rate structure, and/or the procedural obligation often forces the interconnection applicant to rely on one or more manual communication channels. The one or more manual communication channels may include, such as, for example, but not limited to, a phone call and/or an email correspondence, which introduces delays, an inconsistent guidance, and an increased likelihood of an error.

Additionally, existing document retrieval platforms and regulatory databases aggregate large volumes of tariff and regulatory data through web crawling and document ingestion workflows. However, the existing document retrieval platforms and regulatory databases typically present unstructured or minimally contextualized content that requires manual searching, filtering, and interpretation. Further, the existing document retrieval platforms generally fail to provide project-specific guidance based on location, technology type, capacity, voltage level, and/or interconnection scenario. Furthermore, the existing document retrieval platforms lack interactive mechanisms capable of guiding users through complex interconnection processes in real time. As a result, applicants may misunderstand nuanced regulatory requirements, select incorrect interconnection programs, submit incomplete and/or inaccurate applications, and experience repeated resubmissions, delays, and inefficient use of resources.

Existing systems for managing utility tariffs and power grid interconnections provide fragmented and superficial capabilities, often limited to verifying the presence of documents without evaluating substantive content such as technical parameters, signatures, or consistency across submissions, and are generally unable to interpret complex materials including drawings, tables, and flowcharts. Such systems rely on rigid templates, limited contextual data, or human-in-the-loop processes that lack adaptability to evolving regulatory rules and complex interconnection dependencies. As a result, these limitations lead to inefficiencies, delayed project timelines, heightened risk of non-compliance, and the absence of a context-aware, self-adaptive mechanism for dynamically analyzing regulatory data, rate structures, and interconnection requirements in response to user queries.

Consequently, there is a need for improved generative Artificial Intelligence (AI)-based methods and systems for processing regulatory data and power grid interconnections, which may be capable of logically processing regulatory and tariff data to provide an accurate, scalable, and adaptive power grid interconnection decision making and to address at least the aforementioned issues in the prior arts.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

An aspect of the present disclosure may provide a method for processing regulatory data and power grid interconnections using Generative Artificial Intelligence (AI) models. The method may include receiving, by one or more processors, a user query corresponding to an energy management system from at least one user. The user query may correspond to at least one of a power grid process, a regulatory data, and a rate structure data. Further, the method may include extracting, by the one or more processors, query data from the received user query. The query data may include at least one of a customer identifier, a query type, and contextual information corresponding to the user query. Furthermore, the method may include generating, by the one or more processors, one or more sub-queries. The one or more sub-queries may be generated based on the received user query and the extracted query data using one or more Generative Artificial Intelligence (AI) models. In addition, the method may include obtaining, by the one or more processors, first candidate information. The first candidate information obtained may be responsive to at least one of the user query and the generated one or more sub-queries from a vector database. The vector database may include regulatory documents and rate structure documents. Further, the method may include generating, by the one or more processors, a graphical representation of the user query as second candidate information. The graphical representation of the user query as second candidate information generated may be based on at least one of the user query and the one or more sub-queries using a graph-based AI model.

Further, the graphical representation may include entities and relationships between a plurality of rate structure rules, regulatory requirements, interconnection programs, and application attributes. Furthermore, the method may include generating, by the one or more processors, third candidate information responsive to at least one of the user query and the one or more sub-queries. The third candidate information generated may be responsive to at least one of the user query and the one or more sub-queries based on summaries of the rate structure documents and the regulatory documents. In addition, the method may include aggregating, by the one or more processors, the first candidate information, the second candidate information, and the third candidate information into a consolidated context dataset. Further, the method may include analyzing, by the one or more processors, the consolidated context dataset with one or more interconnection attributes associated with the user query. The one or more interconnection attributes may include at least one of a project location, a capacity, a technology type, a voltage level, a point of interconnection, a selected rate structure option, and an application status. Furthermore, the method may include determining, by the one or more processors, at least one interconnection-specific summary for the energy management system based on the one or more interconnection attributes. The interconnection-specific summary may include at least one of an eligibility determination, a required study, a compliance issue, and a recommended interconnection program data. In addition, the method may include generating, by the one or more processors, a refined context data by validating the consolidated context dataset and the interconnection-specific summary using the one or more Gen AI models. Further, the method may include generating, by the one or more processors, a Generative AI response to the user query based on the refined context data. The Generative AI response may include at least one recommendation, at least one compliance instruction and at least one rate structure instruction. Furthermore, the method may include outputting, by the one or more processors, the Generative AI response on a user interface of a user device.

Another aspect of the present disclosure may provide a system for processing regulatory data and power grid interconnections using Generative Artificial Intelligence (AI) models. The system may receive a user query corresponding to an energy management system from at least one user. The user query may correspond to at least one of a power grid process, a regulatory data, and a rate structure data. Further, the system may extract a query data from the received user query. The query data may include at least one of a customer identifier, a query type, and contextual information corresponding to the user query. Furthermore, the system may generate one or more sub-queries based on the received user query and the extracted query data using one or more Generative Artificial Intelligence (AI) models. In addition, the system may obtain first candidate information responsive to at least one of the user query and the generated one or more sub-queries from a vector database. The vector database may include regulatory documents and rate structure documents. Further, the system may generate a graphical representation of the user query as second candidate information based on at least one of the user query and the one or more sub-queries using a graph-based AI model. The graphical representation may include entities and relationships between a plurality of rate structure rules, regulatory requirements, interconnection programs, and application attributes. Furthermore, the system may generate third candidate information. The third candidate information may be responsive to at least one of the user query and the one or more sub-queries based on summaries of the rate structure documents and the regulatory documents. In addition, the system may aggregate the first candidate information, the second candidate information, and the third candidate information into a consolidated context dataset. Further, the system may analyze the consolidated context dataset with one or more interconnection attributes associated with the user query. The one or more interconnection attributes may include at least one of a project location, a capacity, a technology type, a voltage level, a point of interconnection, a selected rate structure option, and an application status. Furthermore, the system may determine at least one interconnection-specific summary for the energy management system based on the one or more interconnection attributes. The interconnection-specific summary may include at least one of an eligibility determination, a required study, a compliance issue, and a recommended interconnection program data. In addition, the system may generate a refined context data by validating the consolidated context dataset and the interconnection-specific summary using the one or more Gen AI models. Further, the system may generate a Generative AI response to the user query based on the refined context data. The Generative AI response may include at least one recommendation, at least one compliance instruction and at least one rate structure instruction. Furthermore, the system may output the Generative AI response on a user interface of a user device.

Yet another aspect of the present disclosure may provide a non-transitory computer readable medium. The non-transitory computer readable medium may include a processor executable instructions, which may cause the processor to receive a user query corresponding to an energy management system from at least one user. The user query may correspond to at least one of a power grid process, a regulatory data, and a rate structure data. The processor may extract a query data from the received user query. The query data may include at least one of a customer identifier, a query type, and contextual information corresponding to the user query. Further, the processor may generate one or more sub-queries based on the received user query and the extracted query data using one or more Generative Artificial Intelligence (AI) models. Furthermore, the processor may obtain first candidate information responsive to at least one of the user query and the generated one or more sub-queries from a vector database. The vector database may include regulatory documents and rate structure documents. In addition, the processor may generate a graphical representation of the user query as second candidate information based on at least one of the user query and the one or more sub-queries using a graph-based AI model. The graphical representation may include entities and relationships between a plurality of rate structure rules, regulatory requirements, interconnection programs, and application attributes. Further, the processor may generate third candidate information responsive to at least one of the user query and the one or more sub-queries based on summaries of the rate structure documents and the regulatory documents. Furthermore, the processor may aggregate the first candidate information, the second candidate information, and the third candidate information into a consolidated context dataset. In addition, the processor may analyze the consolidated context dataset with one or more interconnection attributes associated with the user query. The one or more interconnection attributes may include at least one of a project location, a capacity, a technology type, a voltage level, a point of interconnection, a selected rate structure option, and an application status. Further, the processor may determine at least one interconnection-specific summary for the energy management system based on the one or more interconnection attributes. The interconnection-specific summary may include at least one of an eligibility determination, a required study, a compliance issue, and a recommended interconnection program data. Furthermore, the processor may generate a refined context data by validating the consolidated context dataset and the interconnection-specific summary using the one or more Gen AI models. In addition, the processor may generate a Generative AI response to the user query based on the refined context data. The Generative AI response may include at least one recommendation, at least one compliance instruction and at least one rate structure instruction. Further, the processor may output the Generative AI response on a user interface of a user device.

To further clarify the features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

Features of the disclosed embodiments are illustrated by way of example and not limited in the following Figure(s), in which like numerals indicate like elements, in which:

FIG. 1A illustrates an example block diagram representation of a network architecture for a system capable of processing regulatory data and power grid interconnections using Generative Artificial Intelligence (AI) models, according to an example;

FIG. 1B illustrates an example block diagram representation of a data and network architecture for accessing regulatory rules and rate structure requirements from a centralized regulatory database, a vector database, a vector store, and a knowledge graph for use by the system of FIG. 1A, according to an example;

FIG. 2 illustrates an example block diagram representation depicting a system configuration of the system for processing the regulatory data and power grid interconnections using one or more Generative Artificial Intelligence (AI) models, such as those shown in FIGS. 1A-1B, according to an example;

FIG. 3 illustrates an example flow diagram representation depicting an example method for processing a user query related to the regulatory data and power grid interconnections using one or more Generative Artificial Intelligence (AI) models, according to an example;

FIG. 4 illustrates an example flow diagram representation depicting an example method for processing a user query related to the regulatory data and power grid interconnections using the one or more Generative Artificial Intelligence (AI) models, according to an example;

FIG. 5 illustrates an example flow diagram representation depicting an example method for fine-tuning, validating, and deploying the one or more Generative Artificial Intelligence (AI) models for processing the regulatory data and rate structure documents to execute the user query, according to an example;

FIG. 6 illustrates an example flow diagram representation depicting an example method for processing the user query using the one or more Generative Artificial Intelligence (AI) models with an application review agent, according to an example;

FIG. 7 illustrates an example flow diagram representation depicting an example method for guiding a user through a power grid interconnection application submission process using the one or more Generative Artificial Intelligence (AI) models, according to an example;

FIG. 8 illustrates an example flow diagram representation depicting an example method for processing at least one active and pending power grid interconnection application using the one or more Generative Artificial Intelligence (AI) models, according to an example, according to an example;

FIG. 9 illustrates an example flow diagram representation depicting an example method for generating enriched portions of the regulatory documents and the rate structure documents for use in processing user queries, according to an example;

FIG. 10 illustrates an example flow diagram representation depicting an example method for updating enriched portions of the regulatory documents and the rate structure documents used for processing the user query, according to an example;

FIG. 11 illustrates an example flow diagram representation depicting an example method for processing the user query using the one or more Generative Artificial Intelligence (AI) model, according to an example;

FIG. 12A illustrates an example flow diagram representation depicting an example method for evaluating performance of the one or more Generative Artificial Intelligence (AI) models, according to an example;

FIG. 12B illustrates an example schematic diagram representation depicting a high level functional flow diagram of an example tariff tracker architecture, according to an example;

FIG. 13 illustrates an example block diagram representation of a hardware platform for implementation of a computer system, according to an example; and

FIG. 14 illustrates an example flow diagram representation of a method for processing regulatory data and power grid interconnections using Generative Artificial Intelligence (AI) models, according to an example.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the examples of the present disclosure so as not to obscure the figures with details that will be readily apparent to those skilled in the art having the benefit of the description herein.

### DETAILED DESCRIPTION

For simplicity and illustrative purposes, the proposed approach and solutions are described by referring mainly to examples and embodiments thereof. In the following description, numerous specific details are set forth in order to provide a thorough understanding of the proposed approach and solutions. It will be readily apparent, however, that the proposed approach and solutions may be practiced without limitation to these specific details. In other instances, some methods and structures readily understood by one of ordinary skill in the art have not been described in detail so as not to unnecessarily obscure the ongoing description. As used herein, the terms “a” and “an” are intended to denote at least one of a particular element, the term “includes” means includes but not limited to, the term “including” means including but not limited to, and the term “based on” means based at least in part on, the term “based upon” means based at least in part upon, and the term “such as” means such as but not limited to. The term “relevant” means closely connected or appropriate to what is being performed or considered.

The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional modules.

A computer system (standalone, client, or server computer system) configured by an application may constitute a “module” (or “subsystem”) that is configured and operated to perform certain operations. In one example, the “module” or “subsystem” may be implemented mechanically or electronically, so a module includes dedicated circuitry or logic that is permanently configured (within a special-purpose processor) to perform certain operations. In another example, a ““module” or “subsystem” may also comprise programmable logic or circuitry (as encompassed within a general-purpose processor or other programmable processor) that is temporarily configured by software to perform certain operations.

Accordingly, the term “module” or “subsystem” should be understood to encompass a tangible entity, be that an entity that is physically constructed permanently configured (hardwired), or temporarily configured (programmed) to operate in a certain manner and/or to perform certain operations described herein. Unless otherwise defined, all technical and scientific terms used herein have the same meaning as commonly understood by those skilled in the art to which this disclosure belongs. The system, methods, and examples provided herein are only illustrative and not intended to be limiting.

Generative Artificial Intelligence (AI)-based methods and systems for processing regulatory data and power grid interconnections. In the following description, for the purposes of explanation, numerous specific details are set forth to provide a thorough understanding of the present disclosure. It is apparent, however, that the present disclosure may be practiced without these specific details or with an equivalent arrangement. In other instances, well-known structures and devices are shown in block diagram form in order to avoid unnecessarily obscuring the present disclosure.

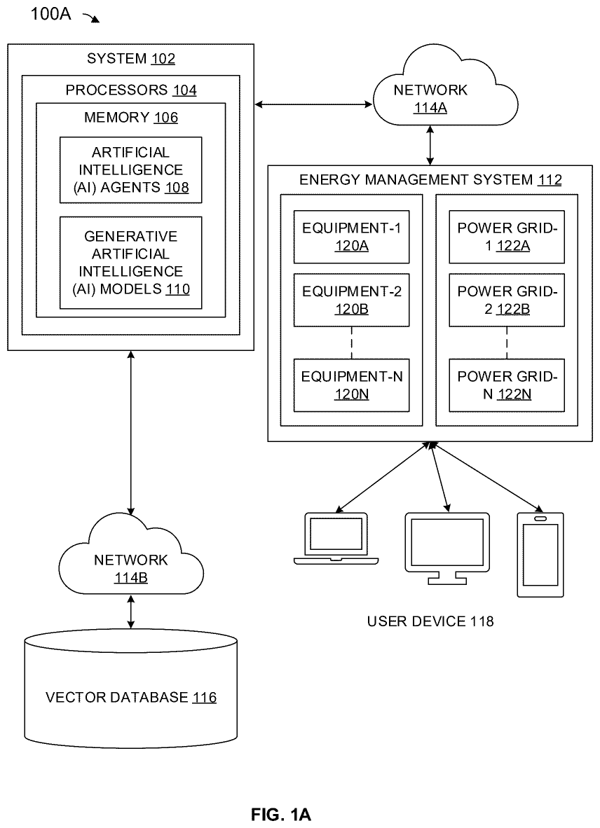

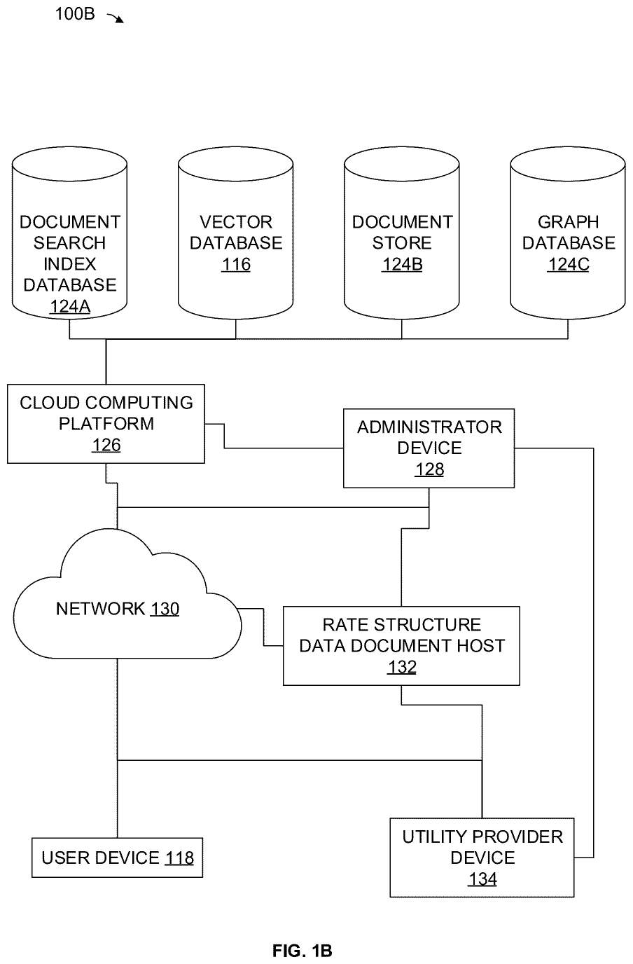

Referring now to the drawings, and more particularly to FIG. 1 through FIG. 14, where similar reference characters denote corresponding features consistently throughout the figures, there are shown preferred examples, and these examples are described in the context of the following exemplary system and/or method.

FIG. 1A illustrates an example block diagram representation of a network architecture 100A for a system 102 capable of processing regulatory data and power grid interconnections using Generative Artificial Intelligence (AI) models, according to an example. The network architecture 100A may include the system 102, a processor 104 (collectively referred to as one or more processors 104), a memory 106, a plurality of modules (not depicted in FIG. 1A), a plurality of Artificial Intelligence (AI) agents 108, one or more Generative Artificial Intelligence (AI) models 110 (interchangeably referred to as one or more Gen AI models 110), an energy management system 112, a network-1 114A, a network-2 114B, a vector database 116, and a user device 118. The energy management system 112 may include a plurality of equipment 120A, 120B, . . . , 120N (collectively referred to as the plurality of equipment 120A-N, and individually referred to as an equipment-1 120A, an equipment-2 120B, through an equipment-N 120N) and a plurality of power grids 122A,122B, . . . , 122N (collectively referred to as the plurality of power grids 122A-N, and individually referred to as a power grid-1 122A, a power grid-2 122B, through a power grid-N 122N).

In an example, the system 102 may be communicatively connected to the energy management system 112 via the network-1 114A. Further, the energy management system 112 may be connected to the user device 118. Furthermore, the system 102 may be communicatively connected to the vector database 116 via the network-2 114B.

In an example, the processor 104 may refer to one or more computational processing units. The processor 104 may be configured to execute instructions for processing the regulatory data and the power grid interconnections using the one or more Generative Artificial Intelligence (AI) models 110. For example, a central processing unit (CPU) may coordinate control logic and workflow orchestration across the plurality of Artificial Intelligence (AI) agents 108, a graphics processing unit (GPU) and/or a tensor processing unit (TPU) may accelerate inference operations for embedding regulatory documents, traversing knowledge graphs, and ranking retrieved information. Further, the processor 104 may be implemented using one or more application-specific integrated circuits (ASICs), one or more field-programmable gate arrays (FPGAs), and/or one or more cloud-based computing resources capable of executing instructions to perform the operations described herein.

In another example, the memory 106 may include one or more volatile and non-volatile storage elements. The memory 106 may be configured to store executable instructions, intermediate computational states, and learned parameters associated with the one or more Generative Artificial Intelligence (AI) models 110 and the plurality of AI agents 108 executed by the system 102. The memory 106 may include, without limitation, a Random Access Memory (RAM), a Read-Only Memory (ROM), one or more solid-state storage devices, and/or a distributed cloud-based storage. The memory 106 may be implemented as a non-transitory computer-readable storage medium communicatively coupled to the processor 104 for executing the operations described herein.

In yet another example, the plurality of modules (not depicted in FIG. 1A) may be implemented as a set of intelligent and intercommunicating software sub-systems. The plurality of modules may collectively provide an automated and adaptive processing of the regulatory data and the power grid interconnections. Each of the plurality of modules may be configured to perform a specialized function, including, without limitation, user query intake and analysis, regulatory and rate structure document ingestion and parsing, vector-based retrieval, graphical representation construction, an analysis of one or more interconnection attributes, an eligibility assessment, a compliance validation, and a Generative Artificial Intelligence (AI) based response generation.

In another example, the plurality of AI agents 108 may include a set of software implemented agents. The plurality of AI agents 108 may be configured to cooperatively process the regulatory data and the power grid interconnections. Each of the plurality of AI agents 108 may be configured to perform a specific function within a distributed workflow. Further, the specific function may include, such as, for example, but not limited to, an analysis of the user query, a generation of one or more sub-queries, a retrieval of the candidate information from the vector database 116, a construction and a traversal of the graphical representation, an analysis of one or more interconnection attributes, the eligibility assessment, the compliance validation, and the Generative Artificial Intelligence (AI) based response generation using the one or more Gen AI models 110.

In another example, the plurality of Artificial Intelligence (AI) agents 108 may be configured to provide an interconnection process between the one or more power generation units, including a renewable energy source. The renewable energy source may include, such as, for example, but not limited to, a solar generation and/or a wind generation system, and the plurality of power grids 122A-N. The plurality of AI agents 108 may include, such as, for example, but not limited to, a rate structure tracking AI agent, an application review AI agent, a customer query resolution AI agent, and an eligibility assessment AI agent. The rate structure tracking AI agent may be configured to extract, monitor, and organize the rate structure data and the regulatory information from at least one of one or more utility websites, one or more industry standards, and one or more jurisdiction specific regulations. The application review AI agent may be configured to validate the power grid interconnection applications and associated technical artifacts against at least one of one or more compliance standards, one or more multi-level regulatory requirements, and one or more historical application outcomes. The customer query resolution AI agent may be configured to respond to the user query relating to at least one of interconnection procedures, application status, and required applicant actions. Further, the customer query resolution AI agent may optionally incorporate a human in the loop learning mechanism to improve response accuracy over time. The eligibility assessment AI agent may be configured to determine eligibility of a project for one or more power grid interconnection programs. Further, the eligibility assessment AI agent may be configured to assist with regulatory alignment. Furthermore, each of the plurality of AI agents 108 may apply at least one of a vector-based search, one or more knowledge graph representations, and the one or more Gen AI models 110 to perform contextual reasoning and efficient processing of the rate structure data and the user query.

In another example, the one or more Generative Artificial Intelligence (AI) models 110 may include at least one of a plurality of machine learning models and a plurality of deep learning models. The one or more Gen AI models 110 may be configured to generate, analyze, and refine outputs for processing the regulatory data and the power grid interconnections. The one or more Gen AI models 110 may be configured to interpret regulatory documents, rate structure documents, and the user query. Further, the one or more Gen AI models 110 may be configured to generate the one or more sub-queries, contextual summaries, eligibility determinations, the compliance guidance, and at least one recommendation for the interconnection-specific summaries. The one or more Gen AI models 110 may utilize a plurality of learning techniques. The plurality of learning techniques may include, such as, for example, but not limited to, a supervised learning, a reinforcement learning, and a natural language processing (NLP). For example, the one or more Gen AI models 110 may include a neural network based inference engine. The neural network based inference engine may be configured to generate structured responses, perform explainability analysis by referencing applicable regulatory clauses and a plurality of rate structure rules, and support iterative refinement of a Generative AI response through a feedback driven optimization. Further, the one or more Gen AI models 110 may thereby provide an adaptive and self-improving regulatory and interconnection analysis framework.

In another example, the energy management system 112 may include a system associated with one or more energy assets and one or more power grid interconnections. The energy management system 112 may be configured to provide a project specific information associated with at least one of an energy generation resource, an energy storage resource, and an energy consumption resource. Further, the project specific information may include the one or more interconnection attributes. The one or more interconnection attributes may include, such as, for example, but not limited to, a project location, a capacity, a technology type, a voltage level, a point of interconnection, a selected rate structure option, and an application status. The energy management system 112 may communicate the one or more interconnection attributes and related user inputs to the system 102 for processing using the one or more Generative Artificial Intelligence (AI) models 110.

In another example, the network-1 114A and the network-2 114B may represent distinct yet interoperable communication layers within the network architecture 100A. The network-1 114A and the network-2 114B may collectively provide secure, parallel, and functionally independent data exchanges. The network-1 114A may be configured to provide real-time and bidirectional communication between the system 102, the energy management system 112, and the user device 118. The network-1 114A and the network-2 114B may thereby provide a transmission of the user query, the one or more interconnection attributes, and the Generative AI response. The network-2 114B may be configured to provide secure data access, retrieval, and synchronization between the system 102 and the vector database 116, including the regulatory documents, the rate structure documents, interconnection program data, and model-related data. The dual-network configuration may support concurrent operations.

In another example, the vector database 116 may include a data repository. The data repository may be configured to store a query vector representation of the regulatory documents, the rate structure documents, and associated textual units. The vector database 116 may store the vector embeddings generated from document sections, clauses, tables, and summaries using an embedding model. The vector database 116 may provide one or more similarity based retrieval operations in response to the user query and/or one or more generated sub-queries. Further, the one or more similarity based retrieval operations may include identifying enriched portions of regulatory data based on vector similarity scores. For example, the vector database 116 may store metadata linking each vector representation to a corresponding document identifier, section reference, or page reference. The vector database 116 may be accessed by the processor 104 to obtain first candidate information for generating the interconnection-specific summaries and the Generative AI response.

In another example, the user device 118 may include a computing device. The user device 118 may be configured to receive a user query as an input. Further, the user device 118 may be configured to output the Generative AI response on a user interface of the user device 118. The user device 118 may include, such as, for example, but not limited to, a desktop computer, a laptop computer, a tablet device, a mobile device, and/or a workstation. Further, the user device 118 may be configured to transmit the user query and the one or more interconnection attributes associated with the energy management system 112 to the system 102 over the network-1 114A. The user device 118 may receive the Generative AI response.

In another example, the plurality of equipment 120A-N may include one or more physical assets and/or one or more virtual energy related assets. The plurality of equipment 120A-N may be associated with the energy management system 112. The plurality of equipment 120A-N may include, such as, for example, but not limited to, a power generation equipment, an energy storage equipment, a load equipment, and an interconnection related equipment. Further, the plurality of equipment 120A-N may include, such as, for example, but not limited to, a photovoltaic system, a wind generation unit, a battery energy storage system, an electric vehicle charging setup, a data center load, a transformer, an inverter, a protection device, and a metering device. Each of the plurality of equipment 120A-N may be associated with the one or more interconnection attributes. The one or more interconnection attributes may include, such as, for example, but not limited to, a capacity, a technology type, a voltage level, a point of interconnection, and an application status. The plurality of equipment 120A-N may provide an equipment specific data to the system 102 for evaluating eligibility, compliance requirements, and an option for an applicable rate structure.

In another example, the plurality of power grids 122A-N may include one or more electrical grid infrastructures. The plurality of equipment 120A-N may be interconnected to the plurality of power grids 122A-N. The plurality of power grids 122A-N may include, such as, for example, but not limited to, a transmission grid, a distribution grid, a microgrid, an utility operated grid, a regional system operator managed grids and/or an independent system operator managed grid. Each of the plurality of power grids 122A-N may be associated with one or more grid specific regulatory rules, interconnection programs, rate structure documents, and operational constraints. The plurality of power grids 122A-N may differ based on at least one of a geographic location, an ownership, a voltage class, and/or a regulatory jurisdiction. Further, an information associated with the plurality of power grids 122A-N may be processed by the system 102 to determine applicable interconnection requirements, the eligibility determination, and the compliance issue for the plurality of equipment 120A-N.

In an example, the system 102 for processing regulatory data and power grid interconnections using the one or more Generative Artificial Intelligence (AI) models 110 may be provided. The system 102 may include the processor 104 and the memory 106. The memory 106 may be communicably coupled to the processor 104. The memory 106 may include processor-executable instructions which, when executed by the processor 104, cause the processor 104 to receive the user query corresponding to the energy management system 112 from at least one user. The user query may correspond to at least one of a power grid process, a regulatory data, and a rate structure data. The processor 104 may extract a query data from the received user query. The query data may include at least one of a customer identifier, a query type, and contextual information corresponding to the user query.

Further, the processor 104 may generate the one or more sub-queries based on the received user query and the extracted query data using the one or more Generative Artificial Intelligence (AI) models 110. In an example, the processor 104 may generate the one or more sub-queries from the received user query by decomposing a complex user query into a plurality of logically independent sub-queries. The one or more sub-queries may be organized in a dependency graph. The dependency graph may define at least one of a parallel path and/or a sequential execution path. Further, the processor 104 may provide an efficient and structured retrieval across the vector database 116. In another example, an ontology based user query expansion may be applied to each of the one or more sub-queries using weighted semantic relationships. The weighted semantic relationships may be derived from the rate structure data and a regulatory terminology. The ontology based expansion may include, such as, for example, but not limited to, direct synonym relationships, a related terminology, hierarchical concepts, and contextual terms. Each of the direct synonym relationships, the related terminology, the hierarchical concepts, and the contextual terms may be assigned a corresponding weight. Further, the corresponding weight may influence a retrieval relevance. Further, the processor 104 may retrieve the first candidate information, the second candidate information and the third candidate information for each of the one or more sub-queries. The first candidate information, the second candidate information and the third candidate information may be retrieved from the vector database 116 and one or more data sources (not depicted in FIG. 1A) using a dynamic source fusion mechanism. The dynamic source fusion mechanism may include semantic similarity search over the vector database 116, relationship traversal within a knowledge graph, and a structured querying of a regulatory database. The vector database 116 and each of the one or more data sources may be assigned a configurable weighting factor. Further, the retrieved results may be further adjusted using at least one of a plurality of source reinforcement factors and a plurality of temporal recency factors. In another example, the processor 104 may compute a confidence score associated with the aggregated retrieval results. Further, the processor 104 may apply one or more fallback thresholds to determine subsequent actions. The processor 104 may generate a response, perform query reformulation and expansion, initiate cross-jurisdictional retrieval, flag the query for human review, and/or escalate the user query to a human expert without providing a substantive automated response based on the confidence score. Further, a confidence based fallback control for a dynamic processing of the user query may be provided. Furthermore, a confidence score associated with a query response may control one or more subsequent system actions. In addition, when the confidence score may be greater than and/or equal to 0.80, the system 102 may proceed with automated response generation. Further, when the confidence score may fall within a range of 0.60 to 0.79, the system 102 may perform query reformulation, expand ontology-based synonyms, and relax retrieval filters. When the confidence score may fall within a range of 0.40 to 0.59, the system 102 may apply aggressive query expansion, initiate cross-jurisdictional retrieval, and flag the query for human review. When the confidence score may be below 0.40, the system 102 may escalate the query to a human expert and suppress generation of a substantive automated response. Further, a plurality of source retrieval weighting parameters may be provided. The system 102 may retrieve and rank contextual information by combining multiple data sources with predefined weighting factors. Furthermore, a semantic similarity retrieval from the vector database 116 may be assigned a weight α of 0.30 to prioritize meaning based matching. Additionally, a relationship traversal and dependency analysis performed using the knowledge graph 124C may be assigned a weight β of 0.25. Further, a structured rule and attribute query from the centralized regulatory database 124A may also be assigned a weight γ of 0.25. Furthermore, a multi-source reinforcement factor δ of 0.10 may be applied to increase confidence when a plurality of sources provide consistent information. In addition, a temporal recency factor ε of 0.10 may be used to prioritize more recent regulatory and rate structure updates during context selection.

Furthermore, the processor 104 may obtain first candidate information responsive to at least one of the user query and the generated one or more sub-queries from the vector database 116. The vector database 116 may include the regulatory documents and the rate structure documents. In addition, the processor 104 may generate the graphical representation of the user query as second candidate information based on at least one of the user query and the one or more sub-queries using a graph-based AI model. In an example, the graph-based AI model may include, such as, for example, but not limited to, a knowledge graph reasoning model, a graph Neural Network (GNN) model, a link prediction model, a rule inference graph model, and/or a hybrid graph-language model. The graph-based AI model may configured to operate over entities and relationships. Further, the processor 104 may transform the user query and the one or more sub-queries into a set of graph nodes. The set of graph nodes may represent the entities including, such as, for example, but not limited to, a rate structure rule, a regulatory requirement, an interconnection program, an application attribute, and one or more project characteristics. Further, the set of graph nodes may generate a plurality of graph edges. The graph edges may represent relationships including, such as, for example, but not limited to, an applicability, a dependency, an eligibility, a constraint, a supersession, and one or more reference relationships. The graph-based AI model may analyze the plurality of nodes and the plurality of edges to infer an additional relationship, propagate constraints across a plurality of related nodes, and identify relevant a subgraph corresponding to the user query. The generated graphical representation may encode structured relationships between a plurality of rate structure rules, regulatory requirements, interconnection programs, and application attributes. Further, the generated graphical representation may be used by the processor 104 to provide at least one of a reasoning, an explainability, and a context refinement for a downstream processing by the one or more Gen AI models 110. The graphical representation may include the entities and the relationships between the plurality of rate structure rules, the regulatory requirements, the interconnection programs, and the application attributes. In an example, prior to and/or during an extraction of the user query and retrieval of the first candidate information, the second candidate information and the third candidate information, the system 102 may perform a multi-modal document processing to preserve at least one semantic relationship across text, tables, and figures within the regulatory documents and the rate structure data documents. The processor 104 may invoke the plurality of Artificial Intelligence (AI) agents 108 operating under a Generative Artificial Intelligence (AI) driven auto discovery architecture to identify, extract, validate, and persist cross-references and hierarchical relationships within the regulatory documents and the rate structure data documents. Further, the plurality of AI agents 108 may include, such as, for example, but not limited to, a structure discovery AI agent (not depicted in FIG. 1A), a reference extraction AI agent (not depicted in FIG. 1A), a keyword linking AI agent (not depicted in FIG. 1A) and a validation AI agent (not depicted in FIG. 1A). The structure discovery AI agent may be configured to identify a document hierarchy including, such as, for example, but not limited to, chapters, sections, and subsections. The reference extraction AI agent may be configured to detect cross-references and citation patterns across text units. Further, the keyword linking AI agent may be configured to extract domain-specific terminology and map semantic relationships among extracted entities. Furthermore, the validation AI agent may be configured to verify correctness and consistency of the extracted relationships between a plurality of text units, a plurality of entities, and a plurality of document components across the regulatory documents and the rate structure data documents. The plurality of relationships may include at least one of hierarchical relationships, reference relationships, definition relationships, dependency relationships, and update relationships linking text, tables, figures, and sections. In addition, the processor 104 may perform a two phase processing workflow. Further, the two phase processing workflow may include a first phase processing workflow and a second phase processing workflow. In the first phase processing workflow, the processor 104 may execute hierarchical extraction by segmenting one or more documents into structural units aligned with the identified document hierarchy. Furthermore, the processor 104 may execute hierarchical extraction by generating a plurality of nodes within a knowledge graph. The plurality of nodes may be connected using relationship types. The relationship types may include at least one of contains, follows, and precedes. In the second phase processing workflow, the processor 104 may process each of the plurality of nodes to extract keywords and references. Further, the processor 104 may generate additional relationship types. The additional relationship types may include at least one of references, cites, defines, and depends on. For example, a cross-reference pattern recognition may be performed by cross-referencing type linking text units. The cross-referencing type linking text units may utilize one or more overlapping corpus segments to capture relationships spanning page boundaries and segmented text units. The overlapping corpus segments may detect of reference patterns. The reference patterns may include at least one of see Table X. Y, per Section X, and detailed in Appendix A. Further, each of the plurality of nodes as extracted may be associated with source document provenance information. The source document provenance information may include at least one of a unique hash based identifier, version metadata, and hierarchical path encoding to provide traceability across document revisions.

In another example, the processor 104 may distinguish among one or more categories of the relationships when generating and maintaining the graphical representation using the graph-based AI model. The one or more categories of the relationships may be auto-discovered. Further, the one or more categories of the relationships may include, such as, for example, but not limited to, structural relationships, reference relationships, semantic relationships, revision relationships, and dependency relationships. For example, the structural relationships may include at least one of contains, follows, precedes, and part of, linking hierarchical text units within the regulatory documents and the rate structure data documents. The reference relationships may include at least one of references, cites, cross references, and incorporates, linking clauses, sections, tables, and figures. The semantic relationships may include at least one of defines, relates to, and synonym of, linking entities and terminology across documents. The revision relationships may include at least one of supersedes, amends, and replaces. Further, the revision relationships may be associated with metadata. The metadata may include, such as, for example, but not limited to, effective dates, scope of applicability, and authority references. The dependency relationships may include at least one of requires, depends on, and enables. Further, the dependency relationships may be associated with at least one of dependency types, conditional criteria, and temporal validity attributes. Furthermore, the processor 104 may implement temporal versioning by creating version chains for nodes within the graphical representation apart from overwriting existing nodes. Each of the plurality of nodes may be associated with version metadata. The version metadata may include, such as, for example, but not limited to, a version identifier, an effective period, and a status selected from current, historical, and superseded. In addition, a conflict resolution for regulatory updates and advice letters may be performed based on detected relationship types. When a direct conflict may be detected, the processor 104 may generate a supersedes relationship and update a status of the affected node to indicate supersession. When partial overlaps may be detected, the processor 104 may split the affected node. Further, the processor 104 may generate one or more new node versions corresponding to only impacted text units. When an update constitutes an extension without conflict, the processor 104 may add new content and associate the new content using reference or dependency relationships without supersession. Furthermore, the processor 104 may trigger a review of the user when conflicts may involve higher authority regulations, retroactive effective dates, and/or semantic inconsistencies not explicitly declared in the source documents.

Further, the processor 104 may generate third candidate information responsive to at least one of the user query and the one or more sub-queries based on summaries of the rate structure documents and the regulatory documents. In an example, the processor 104 may assign rate structure specific terminology to extracted text units and chunks. The rate structure specific terminology may be assigned using an auto discovered ontology. The auto discovered ontology may be generated from structural and semantic features of the regulatory documents and the rate structure data documents. The auto discovered ontology may be dynamically extended based on at least one of a document hierarchy, extracted entities, and detected relationships, apart from relying solely on predefined vocabularies. Further, the processor 104 may perform a plurality of run term assignments using the one or more Generative Artificial Intelligence (AI) models 110. The plurality of run term assignments may include a first run term assignment, a second run term assignment and a third run term assignment. In the first run term assignment, the processor 104 may extract structural terms. The extracted structural terms may include, such as, for example, but not limited to, section titles, headings, and sub-headings. In the second run term assignment, the processor 104 may extract domain-specific keywords associated with each text unit or node. In the third run term assignment, the processor 104 may extract references and relationships among the extracted terms to associate the terms with corresponding rate structure rules, regulatory requirements, interconnection programs, and application attributes. Furthermore, the processor 104 may apply a few shot learning based classification mechanism. The few shot learning based classification mechanism may include an exemplar repository of expert-annotated term classifications. When a confidence score associated with an assigned term may exceed a first threshold, the assigned term may be automatically integrated into the auto discovered ontology. When the confidence score falls within an intermediate range, the assigned term may be queued for batch review. When the confidence score falls below a second threshold, the assigned term may be routed to an expert review queue. In addition, an embedding alignment verification may be performed to ensure consistency between the assigned term and the query vector representation. The processor 104 may perform semantic consistency checks by comparing the vector embeddings with ontology class centroids. Further, the processor 104 may verify cross-store consistency between the vector embeddings stored in the vector database 116 and the vector embeddings associated with corresponding nodes in the knowledge graph. Furthermore, the processor 104 may perform clustering analysis to compare clusters of the vector embedding with ontology class assignments. When a misalignment may be detected, the processor 104 may initiate contrastive alignment training to improve a fidelity of the vector embeddings.

Furthermore, the processor 104 may aggregate the first candidate information, the second candidate information, and the third candidate information into a consolidated context dataset. In addition, the processor 104 may analyze the consolidated context dataset with one or more interconnection attributes associated with the user query. The one or more interconnection attributes may include at least one of the project location, the capacity, the technology type, the voltage level, the point of interconnection, the selected rate structure option, and the application status.

Further, the processor 104 determine at least one interconnection-specific summary for the energy management system 112. The at least one interconnection-specific summary may be determined based on the one or more interconnection attributes. The interconnection-specific summary may include at least one of an eligibility determination, a required study, a compliance issue, and a recommended interconnection program data. In an example, the processor 104 may perform multi-modal validation for diagrams, signatures, and application deficiencies using the one or more Gen AI models 110. In an example, one or more vision enabled Generative AI models may analyze one or more graphical documents. The one or more graphical documents may include, such as, for example, but not limited, single-line diagrams and site plans, to extract graphical and semantic attributes. The extracted attributes may include one or more electrical components with associated ratings, interconnection topology and power flow paths, and one or more annotations. The one or more annotations may include, such as, for example, but not limited to, conductor sizes, distances, and labeling information. The extracted graphical and semantic attributes may be validated against one or more rate structure rules and regulatory requirements, including disconnect locations, protection schemes, grounding requirements, and interconnection constraints. The processor 104 may further perform signature verification on one or more application documents. For digital signatures, the system 102 may verify a certificate chain, validate document integrity, and confirm one or more timestamps. For handwritten signatures, the system 102 may detect signature presence, assess completeness across required fields, and analyze consistency across related documents. The processor 104 may further provide a document integrity by generating cryptographic hashes, including but not limited to one or more cryptographic hash values generated using a secure hashing model, and associating the hashes with stored timestamps to maintain an auditable verification trail. In addition, the processor 104 may generate one or more deficiency flags based on requirements represented in the knowledge graph. The deficiency flags may correspond to applicability filtering, document completeness checks, content validation, and cross-reference validation across multiple submitted documents. Each deficiency flag may be associated with a severity level indicating a critical issue, a major issue, and/or a minor advisory issue. Each detected deficiency may be categorized into one or more severity levels. The one or more severity levels may include, such as, for example, but not limited to, a critical level, a major level, and a minor level. The critical level may block processing. The major level may require correction before continuation. The minor level may provide advisory information without blocking progression. Further, a deficiency flagging logic based on requirements of the knowledge graph may be provided. The application review process may be performed in a plurality of phases, including applicability filtering to select relevant application data based on project capacity, technology type, geographic territory, and interconnection pathway. The process may further include document completeness evaluation to determine presence of required documents and mandatory fields. Further, a content validation may be performed to check values, consistency, and format compliance. Furthermore, a cross-reference validation may be applied to verify alignment and consistency across multiple documents and referenced sections.

Furthermore, the processor 104 may generate a refined context data by validating the consolidated context dataset and the interconnection-specific summary using the one or more Gen AI models 110. In an example, during extraction and processing of the regulatory documents and the rate structure data documents, the processor 104 may utilize the one or more Gen AI models 110. The one or more Gen AI models 110 may include the one or more vision enabled Generative AI models. The one or more vision enabled Generative AI models may be configured to perform at least one of a layout analysis and a multi-modal content extraction without reliance on an existing optical character recognition technique. The one or more vision enabled Generative AI models may be configured to provide semantic understanding of extracted content, context-aware interpretation of ambiguous text, and visual layout comprehension for identifying structural elements within page-wise images. Further, the processor 104 may extract section titles by recognizing visual hierarchy cues. The visual hierarchy cues may include at least one of font size, indentation, spacing, and alignment. Further, the processor 104 may extract effective date information by distinguishing among explicit dates, relative dates, conditional dates, and date ranges present within the documents. The processor 104 may further detect and extract tables and figures by identifying grid patterns, diagram boundaries, and spatial groupings. Further, the processor 104 may extract complete cell contents and preserve row and column structure in the tables. Further, the processor 104 may associate captions with corresponding tables and figures based on spatial proximity and semantic relevance determined by the one or more Gen AI models 110. Further, each extracted table, figure, and associated metadata may be validated against the knowledge graph. The knowledge graph may provide consistency with identified document hierarchy and relationships. Furthermore, the processor 104 may assign confidence scores to extracted multi-modal content. In addition, the processor 104 may initiate at least one of a re-processing, a higher-resolution analysis, and/or a user review when confidence scores may fall below a predefined threshold. In an example, communication and handoff between the plurality of AI agents 108 may be performed using a message based communication protocol. The message based communication protocol may utilize one or more message queues. The one or more message queues may include, such as, for example, but not limited to, a plurality of agent-specific input queues, a plurality of temporary response queues associated with a conversation context, a plurality of dead letter queues for at least one of failed messages and/or un-processable messages, and a plurality of priority queues for at least one of urgent request and/or time-sensitive requests. Further, one or more message queue implementations may include, such as, for example, but not limited to, a distributed message queueing system. The distributed message queueing system may be implemented using at least one of commercially available message brokers and/or in memory data stores configured for a message queuing. Further, an inter agent communication may conform to a standardized message schema to ensure consistency, traceability, and fault isolation. The standardized message schema may include, such as, for example, but not limited to, an envelope portion. The envelope portion may include, such as, for example, but not limited to, a message identifier, a correlation identifier, identifiers of a source agent and a target agent, and a priority indicator. The standardized message schema may further include a context portion. The context portion may include, such as, for example, but not limited to, a conversation identifier, user context data, and accumulated intermediate results generated by the plurality of AI agents 108. Further, a cyclic invocation among the plurality of AI agents 108 may be prevented. Furthermore, the standardized message schema may further include cycle prevention metadata. The cycle prevention metadata may include an invocation chain identifying a plurality of previously invoked AI agents, a hop count indicating a number of AI agent transitions, a maximum hop threshold, and a list of visited AI agents. In addition, the plurality of AI agents 108 may be executed according to a plurality of predefined agent invocation sequences corresponding to a plurality of operational workflows. Further, the plurality of predefined agent invocation sequences may include an eligibility query workflow, an application review workflow. The eligibility query workflow may include, such as, for example, but not limited to, a query intake agent, a tariff tracker agent, an eligibility assessment agent, and a response generation agent. The application review workflow may include, such as, for example, but not limited to, a query intake agent, the one or more vision enabled Generative AI models and a document processing agent, a tariff tracker agent, an application review agent, and a response generation agent. Further, the system 102 may enforce one or more cycle prevention mechanisms during an execution of the plurality of predefined agent invocation sequences. The one or more cycle prevention mechanisms may include rejecting an invocation request when a target AI agent may already be present in an invocation chain. Further, the one or more cycle prevention mechanisms may further include limiting a hop count to a predefined maximum range of approximately five to seven agent transitions. Furthermore, the one or more cycle prevention mechanisms may further include detecting substantially similar payloads using a language-model-based similarity evaluation. In addition, the one or more cycle prevention mechanisms may further include enforcing per-agent execution timeouts in a range of approximately thirty to sixty seconds. Further, the one or more cycle prevention mechanisms may further include enforcing conversation-level timeouts in a range of approximately three to five minutes. Furthermore, the one or more cycle prevention mechanisms may include applying a circuit breaker pattern to monitor and isolate one or more unhealthy AI agents.

In another example, an execution of the ontology based user query expansion and a cross-reference aware retrieval mechanism may improve at least one of a recall response quality, a precision response quality, and an overall response quality relative to a baseline retrieval augmented generation technique. The baseline retrieval augmented generation technique may rely primarily on a vector similarity search. For example, a baseline retrieval performance for the user query relating to the regulatory data and the rate structure data query may exhibit the recall response quality within a top ten ranked result set of approximately 64 percent, the precision response quality within the top ten ranked result set of approximately 48 percent, a mean reciprocal rank of approximately 0.58, and an overall answer accuracy of approximately 67 percent. Further, an ontology driven query expansion may be incorporated with the recall response quality. The recall response quality may be within the top ten ranked result set. Further, the recall response quality may be improved from approximately 64 percent to approximately 79 percent, which may represent an improvement of approximately 23 percent. Similarly, a harmonic mean based relevance metric evaluated within the top ten ranked result set may increase from approximately 55 percent to approximately 62 percent, which may correspond to an improvement of approximately 13 percent. Further, an incorporation of a cross-reference resolution logic may increase completeness for the user query requiring traversal of cross-referenced regulatory sections from approximately 41 percent to approximately 78 percent. Further, an improvement of cross-referenced regulatory sections from approximately 41 percent to approximately 78 percent may represent an improvement of approximately 90 percent. In addition, a complex user query accuracy, including the user query involving conditional thresholds, dependencies, and/or procedural sequencing, may increase from approximately 54 percent to approximately 73 percent. Further, an increase in the complex user query accuracy may correspond to an improvement of approximately 35 percent.

In another example, a combined enhancement strategy may be provided. The combined enhancement strategy may include an auto discovered knowledge graph construction, an ontology based expansion, and a multi source context fusion, recall within the top-ten ranked result set. Further, the combined enhancement strategy may improve from approximately 64 percent to approximately 84 percent. Furthermore, an improvement in the combined enhancement strategy may correspond to an improvement of approximately 31 percent. In addition, an answer accuracy may improve from approximately 67 percent to approximately 81 percent. The answer accuracy may represent an improvement of approximately 21 percent. Further, an answer completeness may increase from approximately 61 percent to approximately 84 percent. Further, an increase in the answer completeness may correspond to an improvement of approximately 38 percent. Additionally, an escalation rate to a user review may decrease from approximately 23 percent to approximately 12 percent. Furthermore, a reduction in the user review may represent a reduction of approximately 48 percent. In addition, a category specific evaluation may include, such as, for example, but not limited to, an eligibility related user query, a timeline related user query, a technical requirement user query, and a procedural user query. Further, an accuracy improvement in the category specific evaluation may be observed. The accuracy improvement from approximately 62 percent to approximately 85 percent may be observed for the eligibility related user query. Further, the accuracy improvement from approximately 58 percent to approximately 79 percent may be observed for the timeline related user query. Furthermore, the accuracy improvement from approximately 69 percent to approximately 83 percent may be observed for the technical requirement user query. In addition, the accuracy improvement from approximately 71 percent to approximately 82 percent may be observed for the procedural user query.

In addition, the processor 104 may generate a Generative AI response to the user query based on the refined context data. The Generative AI response may include at least one recommendation, at least one compliance instruction and at least one rate structure instruction. In an example, one or more golden datasets may be generated for validating tariff-specific and regulatory performance of the one or more Gen AI models 110. The one or more golden datasets may be created using authoritative source documents. The authoritative source documents may include, such as, for example, but not limited to, the rate structure data documents, regulatory rules, interconnection procedures, and compliance standards. Further, the authoritative source documents may be processed through a multimodal extraction workflow using the one or more vision enabled Generative AI models. The one or more golden datasets may include historical application records associated with approved and rejected interconnection applications. Further, each of the historical application records may include at least one of documented outcomes, compliance determinations, and applied rate structure rules. Further, the one or more golden datasets may include expert-curated knowledge. The expert-curated knowledge may be obtained through structured expert review sessions with access to the graphical representation of the knowledge graph. Furthermore, the one or more golden datasets may include synthetically generated scenarios. The one or more Gen AI models 110 may traverse the knowledge graph to generate boundary conditions, edge cases, and exception scenarios. In another example, the one or more golden datasets may further include one or more question and answer pairs. The one or more question and answer pairs may represent a plurality of levels of reasoning complexity. The plurality of levels of reasoning complexity may include, such as, for example, but not limited to, a factual user query, an applied scenario based user query, and a multi-step regulatory reasoning user query. Furthermore, the one or more golden datasets may be used to evaluate at least one of a retrieval accuracy, an answer generation fidelity, a compliance correctness, and a hallucination suppression of the system 102. Further, a domain specific evaluation metrics for rate structure data processing may be provided. The system performance may be evaluated using the domain specific evaluation metrics. Further, a citation accuracy metrics may measure correctness, precision, and recall of cited source material, with target values exceeding 95% precision, 90% recall, and 98% overall correctness. Furthermore, a threshold extraction precision metrics may evaluate accurate identification of numeric limits, eligibility values, and constraints from rate structure data documents, with a target accuracy above 98%. In addition, a temporal consistency metrics may assess correct handling of effective dates, retroactive changes, and versioned rules, with a target score exceeding 97%. Further, a cross-reference resolution rate may measure accurate resolution of intra-document and inter document references, with a target above 90%. Furthermore, a compliance decision accuracy may evaluate agreement between system generated determinations and expert evaluations, with a target exceeding 92% expert agreement. In addition hallucination rate may measure the frequency of unsupported or non-sourced assertions in generated responses, with a target below 2%.

In another example, the system 102 may construct the one or more golden datasets. Further, the system 102 may apply custom tariff compliance metrics to validate accuracy and fidelity of generated responses. The one or more golden datasets may be derived from one or more sources. Further, the one or more golden datasets may include, such as, for example, but not limited to, a historical user query mapped to a corresponding path within the knowledge graph. Further, the one or more golden datasets may preserve relationships between regulatory requirements, rate structure rules, thresholds, and supersession chains. Further, the one or more golden datasets may include synthetic scenarios generated by the one or more Generative Artificial Intelligence (AI) models 110. The synthetic scenarios may be generated by traversing the knowledge graph to simulate boundary conditions, eligibility constraints, and compliance variations. Further, the one or more golden datasets may be verified by a plurality of subject-matter experts. Further, an expert feedback provided by the plurality of subject-matter experts may be reconciled and associated with source documentation to establish ground-truth validation records. Further, the processor 104 may evaluate generated responses using a combination of retrieval augmented generation assessment metrics and domain specific tariff compliance metrics. The retrieval augmented generation assessment metrics may include, such as, for example, but not limited to, faithfulness, answer relevancy, context precision, and context recall. The domain specific tariff compliance metrics may include, such as, for example, but not limited to, tariff citation accuracy, threshold precision, compliance determination accuracy, and temporal correctness. In another example, the processor 104 may compute a weighted composite performance score based on predefined metric weights. The weighted composite performance score may be used to classify a performance of the system 102 into a plurality of qualitative ranges. The plurality of qualitative ranges may include, such as, for example, but not limited to, excellent, good, fair, and poor. Further, the performance of the system 102 be used to trigger at least one of a Generative AI model refinement, a Generative AI model retraining, and/or escalation workflows. Further, custom tariff compliance metrics may be provided. The custom tariff compliance metrics may include, such as, for example, but not limited to, example evaluation metrics and associated components used to assess system outputs, including tariff citation accuracy based on presence, correctness, relevance, and currency of cited rate structure rules. The custom tariff compliance metrics may further include threshold precision based on value accuracy, unit consistency, operator accuracy, and contextual accuracy. Further, the custom tariff compliance metrics may further include compliance determination accuracy based on binary accuracy, conditional accuracy, reasoning validity, and expert agreement. In addition, the custom tariff compliance metrics may include temporal correctness based on effective date awareness, version currency, and deadline accuracy. Further, weighted composite evaluation metrics may be provided. The weighted composite evaluation metrics may include a plurality of example weighting percentages applied to the weighted composite evaluation metrics when computing a composite score, including faithfulness at 20%, answer relevancy at 15%, context precision at 10%, context recall at 10%, tariff citation accuracy at 15%, threshold precision at 10%, compliance accuracy at 15%, and temporal correctness at 5%. In addition, a plurality of performance classification thresholds may be provided. The plurality of performance classification thresholds may include, such as, for example, but not limited to, a plurality of example classification ranges for a composite score. The example classification ranges for the composite score may include a range of 90% to 100%, which may denote an excellent range for the composite score. Further, the composite score may include a range from 80% to 89%, which may denote a good range. Furthermore, the composite score may include a range from 70% to 79%, which may denote a fair range. In addition, the composite score may include scores below 70%, which may denote a poor range.

Further, the processor 104 may output the Generative AI response on the user interface of the user device 118. In an example, the processor 104 may identify regulatory updates. The identified regulatory updates may include, such as, for example, but not limited to, advice letters by applying the one or more Generative Artificial Intelligence (AI) models 110. The one or more Gen AI models 110 may be configured to perform structural and semantic analysis of one or more rate structure data provider websites. The one or more Gen AI models 110 may perform at least one document object model (DOM) pattern recognition. The at least one document object model (DOM) pattern recognition may identify document identifiers, publication dates, status indicators, and document access links without manual configuration of website structures. Further, the processor 104 may perform semantic differencing between current and prior versions of the regulatory documents and the rate structure data documents to determine regulatory significance of detected updates. The semantic differencing may identify substantive changes. The substantive changes may include at least one of semantic equivalence in reworded content, modifications to numeric thresholds, and changes to effective dates. Further, the substantive changes may impact interconnection application timelines. Furthermore, the processor 104 may compute a relevancy score for each detected update using the one or more Gen AI models 110. The relevancy score may be represented on a continuous scale. Further, the relevancy score may be based on one or more factors. The one or more factors may include relevance to interconnection procedures, relevance to affected utilities and interconnection programs, geographic applicability, temporal urgency, estimated user impact. Further, the one or more factors may impact on the graphical representation and the consolidated context dataset. Furthermore, the processor 104 may trigger one or more actions based on the relevancy score as computed. When the relevancy score may exceed a first threshold, the processor 104 may initiate immediate index updates, embedding generation, knowledge graph update operations, and transmission of proactive alerts to the user. When the relevancy score may fall within an intermediate range, the processor 104 may initiate batch processing, route the update to a human review queue, and transmit conditional alerts. When the relevancy score may fall below a second threshold, the processor 104 may archive the update for periodic review without transmitting alerts.

In another example, the processor 104 may propagate delta changes to the vector embeddings and the graphical representation without performing full reprocessing of the regulatory documents and the rate structure data documents. The processor 104 may apply the one or more Gen AI models 110 to perform semantic change detection. The semantic change detection may be performed by comparing updated document content with existing nodes and the relationships in the graphical representation. Further, the processor 104 may classify detected changes into one or more categories. The one or more categories may include, such as, for example, but not limited to, a no substantive change category, a non-substantive change category, substantive change category, and a structural change category. The no substantive change category and the non-substantive change may include formatting modifications and/or typographical corrections. The formatting modifications and/or typographical corrections may not alter regulatory meaning. The substantive change category may include modifications to rules, requirements, thresholds, and/or conditions. The structural change category may include at least one of a reorganization of content and a preservation semantic meaning. Furthermore, the processor 104 may perform selective update operations based on the classified change type. When added content may be detected, the processor 104 may execute a multi-phase extraction pipeline. The multi-phase extraction pipeline may include, such as, for example, but not limited to, a text extraction, a relationship discovery, a summarization, and a embedding generation of one or more regulatory documents and one or more rate structure data documents. The one or more regulatory documents and the one or more rate structure data documents may include corresponding text units, tables, figures, and associated metadata. When modified content may be detected, the processor 104 may selectively re-embed only portions determined to be substantively changed. When deleted content may be detected, the processor 104 may retain the plurality of corresponding nodes and mark the plurality of nodes as superseded using revision relationships without an immediate removal. When relocated content may detected, the processor 104 may update a structure of the graphical representation and the relationships without re-embedding unchanged content. In addition, the processor 104 may handle retroactive effective dates associated with detected updates. The retroactive effective dates may be handled by analyzing query logs to identify at least one of a previously affected user query, a flagging of an active and/or pending interconnection application for re-review, invalidation of cached responses generated prior to the effective date, and transmitting notifications to at least one of the user and an administrator. Further, the processor 104 may provide the user query and an audit view. The user query may be a point in time user query. Further, the audit view may provide a retrieval of regulatory interpretations applicable to specific historical time periods.

In another example, the system 102 may capture operational insights to support continuous model refinement and escalation reduction. The processor 104 may maintain logging records including query text, timestamps, processing actions, confidence scores, resolution outcomes, and user feedback, and may detect and store query reformulation events using sequential analysis and semantic similarity detection to identify terminology gaps and retrieval weaknesses. Further, human-generated responses provided during escalations may be evaluated by the one or more Gen AI models 110 and used to enrich the knowledge graph through additional nodes and relationships, and to update one or more few-shot exemplar banks. Furthermore, corrective interventions may include ingesting additional source documents, adding weighted synonyms and cross-references, introducing representative exemplars, and tuning exemplar selection or node and relationship weighting, thereby progressively reducing escalation frequency while maintaining response quality and user satisfaction. In another example, the system 102, and methods disclosed hereinafter may be deployed using a microservices based software architecture. The microservices based software architecture may be configured to provide at least one of a secure on premises operation and a jurisdiction specific data isolation. The microservices based software architecture may define one or more service boundaries. The one or more service boundaries may include, such as, for example, but not limited to, a query processing service, a retrieval service, an agent orchestration service, and a knowledge management service. The query processing service may operate in a stateless manner. Further, the query processing service may scale in proportion to query volume. The retrieval service may be optimized for at least one of a read intensive operation and shardable based on document collections. The agent orchestration service may be configured to coordinate multi-agent workflows. The knowledge management service may be configured for write-intensive operations during data ingestion. Additionally, the plurality of AI agents 108 may be provided for processing regulatory documents and rate structure data documents. Further, the plurality of AI agents 108 may be configured to scale during ingestion operations and scale down during steady-state operation. Further, the one or more vision enabled Generative AI models may be configured to utilize accelerator hardware and scale based on at least one of a queue depth and a processing demand of the system 102. Further, the software architecture may implement a layered encryption scheme to protect sensitive regulatory data and rate structure data. Furthermore, the rate structure data stored at rest may be encrypted using a symmetric encryption with at least one of authenticated encryption modes and tenant-specific encryption keys. The at least one of authenticated encryption modes and tenant-specific encryption keys may be managed by a secure key management hardware. In addition, the rate structure data may be transmitted between one or more components of the system 102. Further, the rate structure data may be protected using at least one of a transport-layer encryption, a mutual authentication based transport encryption. The transport-layer encryption may be provided for one or more external communication channels. The mutual authentication based transport encryption for an internal service to service communication. Further, at an application level, selected data fields may be protected using at least one of a field-level encryption, and one or more secrets. The at least one of the field-level encryption, and the one or more secrets may be used by one or more services. The one or more services may be securely managed using a centralized secret management service. Further, the selected data fields may include sensitive information.

Furthermore, the system 102 may be deployed entirely on-premises without reliance on one or more external application programming interfaces (not depicted in FIG. 1A). Further, the system 102 may be deployed in one or more deployments. The one or more deployments may include, such as, for example, but not limited to, a local execution of the one or more Gen AI models 110 for inference, local execution of the one or more vision enabled Generative AI models on accelerator infrastructure, local generation of vector embeddings, local storage and execution of knowledge graph databases, and local storage of few-shot exemplar data. In an example, an optional external connectivity may be provided with the system 102. The optional external connectivity may be selectively enabled and/or disabled. The optional external connectivity may include, such as, for example, but not limited to, a full air-gapped operation where no external network access may be permitted.

In another example, the system 102 may provide one or more regionalized deployments. In the one or more regionalized deployments, a complete data isolation may be maintained on the basis of one or more regions. Further, the one or more regionalized deployments may include, such as, for example, but not limited to, separate service stacks per region, region specific databases, vector stores, and knowledge graphs, and configuration overlays. Furthermore, the one or more regionalized deployments may encode at least one of region specific regulatory rules, the rate structure data, and compliance requirements. In another example, the system 102 may further incorporate scalability mechanisms. The scalability mechanisms may include, such as, for example, but not limited to, a horizontal scaling of stateless services, read replicas and sharding for stateful services, an automated scaling.

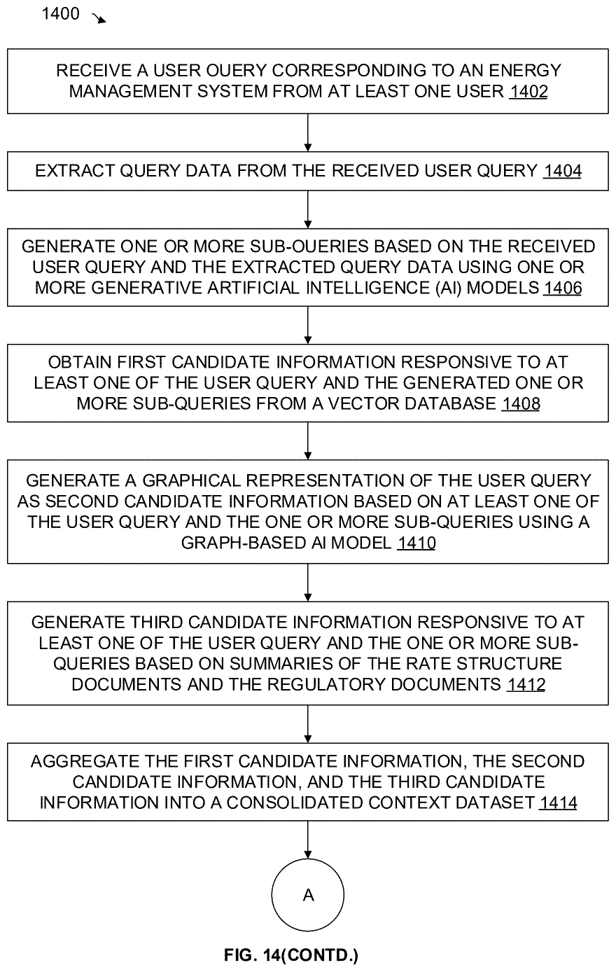

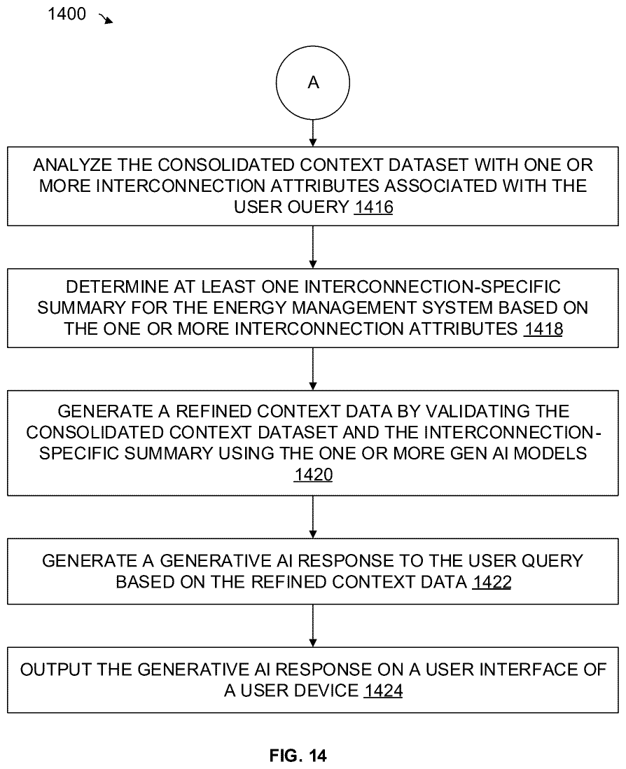

While the processors, components, elements, systems, subsystems, and/or computing devices described herein may be shown as single blocks or components, one of ordinary skill in the art would appreciate that such single components may represent multiple interconnected elements, which may be connected via the network-1 114A and the network-2 114B. It may be appreciated that data flows and control flows among the components and modules illustrated in FIGS. 1-14 may correspond to the plurality of processing operations described herein for processing regulatory data and power grid interconnections. Although, FIGS. 1-14 depict inter-component relationships in a structural and/or architectural manner, the directionality of data exchange, invocation of the plurality of AI agents 108, and control sequencing may follow a logical processing order defined by the method steps of FIG. 14 and the functional descriptions of the system components. Accordingly, the illustrated connections may be provided for explanatory purposes and may not limit the sequence, concurrency, and/or dependency of operations performed by the system 102.

The system 102 may further include one or more middleware components (not shown in FIGS. 1-14) configured to provide a software level support and a platform level support for communication and interoperability among the vector database 116, the energy management system 112, the user device 118, and the processor 104 executing the plurality of modules (not depicted in FIG. 1A). Such middleware components may manage message routing, data transformation, authentication, authorization, and service orchestration across the network-1 114A and the network-2 114B to provide secure and efficient exchange of regulatory documents, rate structure data, interconnection attributes, intermediate results, and Generative Artificial Intelligence (AI) responses. In some examples, the one or more middleware components may be optional and dependent on a deployment configuration of the system 102. Further, additional servers, middleware platforms, and/or network services (not depicted in FIGS. 1-14) may also be deployed at a front-end or back-end of the system 102 to provide at least one of a monitoring operation, a logging operation, an auditing operation, a diagnostics operation, and/or a control operation associated with processing the regulatory data and the power grid interconnections.

FIG. 1B illustrates an example block diagram representation of a data and network architecture 100B for accessing regulatory rules and rate structure requirements from a centralized regulatory database 124A, the vector database 116, a vector store 124B, and a knowledge graph 124C for use by the system 102 of FIG. 1A, according to an example. The data and network architecture 100B may include the centralized regulatory database 124A, the vector database 116, the vector store 124B, and the knowledge graph 124C. Each of the centralized regulatory database 124A, the vector database 116, the vector store 124B, and the knowledge graph 124C may be configured to store and provide the regulatory documents, the rate structure documents, the vector embeddings, and the graphical representation. The data and network architecture 100B may further include a cloud computing platform 126 communicatively coupled to the centralized regulatory database 124A, the vector database 116, the vector store 124B, and the knowledge graph 124C to provide scalable processing and data access. Further, the user device 118, an administrator device 128, and a rata structure data provider device 134 may communicate within the data and network architecture 100B through a network 130. For example, a rate structure data document host 132 may provide the rate structure documents and updates thereto for storage and processing within the data and network architecture 100B. Further, the rate structure data document host 132 may provide an analysis of the regulatory data and a workflow for at least one active and pending power grid interconnection application. The data and network architecture 100B may further include the cloud computing platform 126, the administrator device 128, the network 130, the rate structure data document host 132, the user device 118, and the rate structure data provider device 134. Further, a communication among components of the data and network architecture 100B may be implemented using wired and/or wireless communication channels. Furthermore, the communication may be facilitated by the network 130, which may include the Internet and/or one or more private or public networks. The rate structure data document host 132 may include one or more websites, repositories, and/or databases configured to store and/or provide access to rate structure data documents, including updates, revisions, and regulatory notices. In some examples, the rate structure data document host 132 may be integrated within, and/or communicatively coupled to, the rate structure data provider device 134.

The administrator device 128, the user device 118, and the rate structure data provider device 134 may each include one or more computing devices, including but not limited to desktop computers, servers, terminals, or mobile devices. Each such device may include the one or more processors 104, the memory 106, user input/output components, and display interfaces configured to present information including user interfaces, alerts, recommendations, and reports. The user device 118 may enable a user to interact with one or more components of the data and network architecture 100B to submit queries and receive responses related to rate structure data. The rate structure data provider device 134 may enable a rate structure data provider to interact with the data and network architecture 100B to manage rate structure data documents, initiate updates, configure workflows, review outputs, train personnel, and/or invoke one or more processes disclosed herein. The administrator device 128 may include one or more computing devices configured to communicate with the cloud computing platform 126 and/or the rate structure data provider device 134 via direct and/or network-based communication. The administrator device 128 may be configured to control, configure, and/or execute one or more processes disclosed herein in cooperation with the cloud computing platform 126.

The cloud computing platform 126 may comprise one or more computing systems including the one or more processors 104, the memory 106, and storage resources configured to execute one or more methods disclosed herein. In some examples, the cloud computing platform 126 may host, execute, and/or manage the one or more Generative Artificial Intelligence (AI) models 110, including large language models, neural networks, and associated processing pipelines used to perform enrichment, retrieval, reasoning, and response generation operations. The centralized regulatory database 124A may store authoritative regulatory rules, compliance requirements, and official updates. The vector database 116 may store vector embeddings associated with rate structure data documents, document segments, and enriched content to support semantic retrieval. The vector store 124B may maintain indexed representations for efficient similarity search. The knowledge graph 124C may store structured entities, relationships, dependencies, and cross-references derived from rate structure data documents. Together, these data repositories may support search, retrieval, reasoning, and explainability functions executed by the data and network architecture 100B.

In an example, the plurality of modules (not depicted in FIG. 1B) may cause the processor 104 to detect an update to at least one rate structure rule and a regulatory requirement stored in the centralized regulatory database 124A. Further, the plurality of modules may cause the processor 104 to determine an impact of the detected update on at least one active and pending power grid interconnection application based on the interconnection-specific summaries. Furthermore, the plurality of modules may cause the processor 104 to transmit an alert to at least one user associated with the at least one active and the pending power grid interconnection application. The alert may indicate the update and the impact on the interconnection application.

In an example, once a revision to the rate structure data documents may be detected, the system 102 may selectively re-process only an affected rate structure data document from the rate structure data documents. The affected rate structure data document may include, such as, for example, but not limited to, segments, embeddings, and graph nodes. Further, the system 102 may preserve an unaffected content. Furthermore, the system 102 may thereby reduce a computational overhead and maintain a historical traceability of the rate structure documents.

In another example, a knowledge graph generation and querying mechanism may be provided. The knowledge graph generation and querying mechanism may be configured to process, index, and interrelate the regulatory documents, the rate structure data documents, and advisory update documents. The knowledge graph 124C may be generated using the one or more Generative Artificial Intelligence (AI) models 110. Further, the knowledge graph 124C may represent one or more fine-grained relationships among at least one of concepts, rules, clauses, and revisions. Furthermore, the knowledge graph 124C may provide at least one of an advanced reasoning, a traceability, and a query resolution for the user query. In another example, the knowledge graph generation mechanism may receive an input corpus. The input corpus may include, such as, for example, but not limited to, base regulatory documents and the rate structure data documents, and the advisory update documents. The advisory update documents may introduce amendments, additions, and/or cross-references. The advisory update documents may be segmented into a plurality of discrete text units. The plurality of discrete text units may include, such as, for example, but not limited to, paragraphs, sections, and/or subsections. Further, the plurality of discrete text units may provide at least one of a fine grained referencing representation and a node level representation within the knowledge graph 124C.

In another example, the one or more Gen AI models 110 may extract entities, relationships, and assertions from each of the plurality of discrete text units. The extracted entities may include, such as, for example, but not limited to, concepts, rules, clauses, and defined terms. The extracted relationships may include, such as, for example, but not limited to, cross-references, amendments, dependencies, and expansions. The extracted assertions may represent at least one of a key regulatory statement and/or a rate structure statement associated with each of the plurality of discrete text units. Further, the extracted relationships may be classified into a plurality of relationship types. The plurality of relationship types may include, such as, for example, but not limited to, one or more conceptual hierarchy relationships, one or more rule to clause relationships, one or more cross reference relationships, or more amendment relationships, one or more reference relationships and one or more addition relationships. The one or more conceptual hierarchy relationships may link concepts and sub-concepts. The one or more rule to clause relationships may link regulatory rules to corresponding clauses. The one or more cross reference relationships may capture at least one of an explicit reference and/or an implicit reference between the plurality of discrete text units. The one or more amendment relationships may indicate updates and/or overwrites introduced by the advisory documents. The one or more reference relationships may indicate advisory documents that reference base documents. The one or more addition relationships may represent a newly introduced content.

In some examples, a community detection operation may be performed on the knowledge graph 124C using one or more hierarchical clustering techniques. The one or more hierarchical clustering techniques may group related nodes into a plurality of communities. The plurality of communities may correspond to at least one of regulatory topics, program groupings, or rule families. Each of the plurality of communities may be summarized using a bottom up summarization process. The bottom up summarization process may provide summaries. The summaries may capture key entities and relationships for a higher level interpretation by the system 102.

In addition, the knowledge graph mechanism may generate the vector embeddings for at least one of a plurality of entities and the plurality of discrete text units. Further, the embeddings for the plurality of entities may be generated within a graph aware vector space. Furthermore, the embedding for the plurality of discrete text units may be generated within a textual vector space. The vector embeddings may be used to provide a hybrid query execution. The hybrid query execution may combine at least one of a symbolic graph traversal and a semantic similarity search. The knowledge graph 124C may provide a plurality of query modes. The plurality of query modes may include a global query mode, a local query mode and an expanded query mode. The global query mode may be configured to retrieve a high level insight from the summaries. The local query mode may be configured to retrieve an entity centric information by traversing a plurality of neighboring nodes and the plurality of discrete text units. The expanded query mode may be configured to augment the user query with a community level context to improve at least one of a retrieval breadth of a response and a response completeness.

In another example, the plurality of nodes within the knowledge graph 124C may include a concept node, a rule node, text unit node, and an advisory update node. The concept node may represent at least one of an abstract entity and/or a concrete regulatory entities. The rule node may represent regulatory rules and/or rate structure rules. The clause node may represent specific provisions within rules. The text unit node may represent atomic segments of the source documents. The advisory update node may represent documents introducing revisions and/or references. The edge types may include, such as, for example, but not limited to, a plurality of concept to sub concept relationships, a plurality of rule to clause relationships, a plurality of cross reference relationships, a plurality of amendment relationships, a plurality of reference relationships and a plurality of addition relationships. The plurality of concept to sub concept relationships may represent at least one hierarchical structure. The plurality of cross reference relationships may be provided between sections and/or clauses. The plurality of amendment relationships may link advisory updates to modified provisions. The plurality of reference relationships may link advisory updates to referenced provisions. The plurality of addition relationships may link the advisory updates to newly introduced entities and/or rules.

In an example, the knowledge graph 124C may be traversed to identify amendments to a specified regulatory rule. The specified regulatory rule may be introduced by an advisory update document. In another example, the knowledge graph 124C may be queried to identify clauses cross-referenced by a given clause within a regulatory rule. For example, a global query may retrieve summarized concepts related to a regulatory topic across the corpus. Further, a generation and a querying mechanism of the knowledge graph 124C may provide a dynamic representation of regulatory and rate structure data. The knowledge graph 124C may provide at least one of a revision tracking and a dependency analysis. Further, the knowledge graph 124C may provide at least one efficient and explainable resolution of the user query, which may be complex.

In another example, in generating the Generative AI response to the user query based on the refined context data, the plurality of modules may cause the processor 104 to receive project information associated with a power generation project of the energy management system 112 from the at least one user. The project information may include at least one of a location, a capacity, a project type, and a point of interconnection. Further, the plurality of modules may cause the processor 104 to access a knowledge base storing program eligibility criteria, rate structure plans, and compliance rules. The knowledge base storing program eligibility criteria, rate structure plans, and compliance rules may be based on the received project information. The knowledge base may include at least one of the knowledge graph 124C, the vector store 124B, and the centralized regulatory database 124A. Furthermore, the plurality of modules may cause the processor 104 to determine one or more interconnection programs and rate structure plans applicable to the project information. The one or more interconnection programs and the rate structure plans applicable to the project information may be determined by mapping the project information to eligibility criteria represented in the knowledge base. In addition, the plurality of modules may cause the processor 104 to generate eligibility results. The eligibility results may include an indication of at least one eligible interconnection program and an associated rate structure plan. Further, the plurality of modules may cause the processor 104 to generate the at least one recommendation based on the generated eligibility results. The at least one recommendation may include at least one of a relevant project configuration, a required study, an applicable rate structure, and a regulatory alignment step. Furthermore, the plurality of modules may cause the processor 104 to generate a compliance guidance data for the power generation project based on the at least one recommendation. The compliance guidance data may include at least one required document, a permit, a site plan, and a single-line diagram. In addition, the plurality of modules may cause the processor 104 to generate a step-by-step guided submission workflow. The step-by-step guided submission workflow may be generated based on the eligibility results, the at least one recommendation and the compliance guidance data. Further, the plurality of modules may cause the processor 104 to prompt the at least one user for interconnection application data. The at least one user for interconnection application data may be prompted based on the step-by-step guided submission workflow in response to receiving an indication to proceed with submission from the at least one user. Furthermore, the plurality of modules may cause the processor 104 to generate one or more interconnection forms using the project information and the interconnection application data. In addition, the plurality of modules may cause the processor 104 to transmit the one or more interconnection forms and associated documents for submission to a system operator. Further, the plurality of modules may cause the processor 104 to generate explainability information indicating at least one reason for an eligibility determination and an ineligibility determination. The explainability information may reference one or more specific rate structure rules and regulatory clauses applied. Furthermore, the plurality of modules may cause the processor 104 to output the explainability information with the eligibility results.

In another example, the plurality of modules may cause the processor 104 to receive the interconnection application data from the at least one user. the interconnection application data may include structured application data and a plurality of attached documents. Further, the plurality of modules may cause the processor 104 to extract application details from the structured application data and the plurality of attached documents. The application details may include at least one of applicant information, a rate-structure selection, a site control information, permit information, engineering studies, site plans, and single-line diagrams. Furthermore, the plurality of modules may cause the processor 104 to access regulatory rules and rate structure requirements from the centralized regulatory database 124A, the knowledge graph 124C, and the vector store 124B. In addition, the plurality of modules may cause the processor 104 to determine whether the interconnection application data satisfy a plurality of compliance checks based on the regulatory rules and the rate structure requirements. Further, the plurality of modules may cause the processor 104 to generate at least one recommendation indicating at least one corrective action to rectify at least one compliance issue. The at least one recommendation indicating at least one corrective action to rectify at least one compliance issue may be generated based on the at least one compliance issue detected. Furthermore, the plurality of modules may cause the processor 104 to validate the interconnection application data based on historical application data and the plurality of compliance checks being satisfied. In addition, the plurality of modules may cause the processor 104 to generate a review summary for the interconnection application data based on results of validation. The review summary may include at least one of verified application details, compliance confirmation, and the at least one corrective action.

Further, the self-RAG architecture may implement a multi-stage query processing workflow configured to decompose a user query into one or more structured sub-queries to enable context-aware response generation. The vector store 124B may support similarity-based and keyword-based retrieval over embeddings and metadata. Furthermore, a human in the loop (HITL) workflow may incorporate user feedback stored in memory 106 to refine behavior of the one or more Generative AI models 110, including selective updates to embeddings, knowledge graph relationships, and few-shot exemplars without full model retraining. The system 102 and methods described hereinafter may provide support regulatory compliance, eligibility assessment, interconnection application processing, and rate structure data tracking using the one or more Generative AI models 110. The plurality of AI agents 108 may generate structured responses including recommendations, references, and compliance guidance.

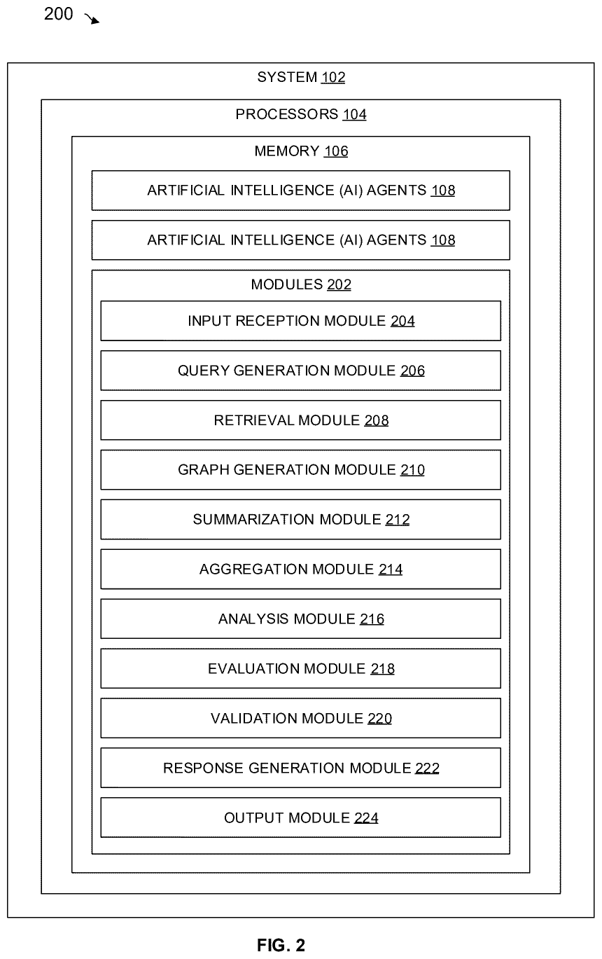

FIG. 2 illustrates an example block diagram representation depicting a system configuration 200 of the system 102 for processing the regulatory data and the power grid interconnections using the one or more Generative Artificial Intelligence (AI) models 110, such as those shown in FIGS. 1A-1B, according to an example. The system 102 may include the processor 104 and the memory 106. The memory 106 may be communicably coupled to the processor 104. The memory 106 may include processor-executable instructions. The memory 106 may the plurality of AI agents 108, the one or more Gen AI models 110 and the plurality of modules 202. The plurality of modules 202 may include an input reception module 204, a query generation module 206, a retrieval module 208, a graph generation module 210, a summarization module 212, an aggregation module 214, an analysis module 216, an evaluation module 218, a validation module 220, a response generation module 222, an output module 224 and the like modules (not depicted in FIG. 2).

In an example, the input reception module 204 may receive the user query corresponding to the energy management system 112 from at least one user. The query generation module 206 may extract a query data from the received user query. Further, the query generation module 206 may generate the one or more sub-queries based on the received user query and the extracted query data using the one or more Generative Artificial Intelligence (AI) models 110. Furthermore, the retrieval module 208 may obtain first candidate information responsive to at least one of the user query and the generated one or more sub-queries from the vector database 116. In addition, the graph generation module 210 may generate the graphical representation of the user query as second candidate information based on at least one of the user query and the one or more sub-queries using a graph-based AI model. Further, the summarization module 212 may generate third candidate information responsive to at least one of the user query and the one or more sub-queries based on summaries of the rate structure documents and the regulatory documents. Furthermore, the aggregation module 214 may aggregate the first candidate information, the second candidate information, and the third candidate information into the consolidated context dataset. In addition, the analysis module 216, may analyze the consolidated context dataset with one or more interconnection attributes associated with the user query. Further, the evaluation module 218 determine at least one interconnection-specific summary for the energy management system 112. Furthermore, the validation module 220 may generate a refined context data by validating the consolidated context dataset and the interconnection-specific summary using the one or more Gen AI models 110. In addition, the response generation module 222 may generate a Generative AI response to the user query based on the refined context data. Further, the output module 224 may output the Generative AI response on the user interface of the user device 118.

In another example, in generating the one or more sub-queries based on the received user query and the extracted query data using the one or more Generative Artificial Intelligence (AI) models 110, the plurality of modules 202 may cause the processor 104 to analyze the user query to identify at least one of keywords, ontology terms, and synonyms. The plurality of modules 202 may cause the processor 104 to predict a query nature including at least one of a detailed query and a summary query. Further, the plurality of modules 202 may cause the processor 104 to generate the one or more sub-queries expanded with the ontology terms and weighted keywords based on the predicted query nature.

In another example, in obtaining the first candidate information responsive to the at least one of the user query and the generated one or more sub-queries from the vector database 116, the plurality of modules 202 may cause the processor 104 to generate a query vector representation for at least one of the user query and each of the one or more sub-queries using an embedding model. The plurality of modules 202 may cause the processor 104 to perform a similarity search in the vector database 116. The similarity search may be performed using the query vector representation to identify vector embeddings of enriched portions of the regulatory documents and the rate structure documents similar to the query vector representation. Further, the plurality of modules 202 may cause the processor 104 to compute similarity scores. The similarity scores may be computed between the query vector representation and the identified vector embeddings using a similarity metric. The similarity metric may include a cosine similarity metric. Furthermore, the plurality of modules 202 may cause the processor 104 to select a plurality of top-ranked vector embeddings based on the computed similarity scores. In addition, the plurality of modules 202 may cause the processor 104 to retrieve the enriched portions. The enriched portions retrieved may correspond to the plurality of top-ranked vector embeddings from the vector database 116. Further, the plurality of modules 202 may cause the processor 104 to output the enriched portions as the first candidate information.

In another example, in generating the graphical representation of the user query as the second candidate information based on at least one of the user query and the one or more sub-queries using the graph-based AI model, the plurality of modules 202 may cause the processor 104 to classify the regulatory documents and the rate structure documents into text units. The text units may include at least one of paragraphs and sections. Further, the plurality of modules 202 may cause the processor 104 to extract a plurality of entities from each text unit using the graph-based AI model. The plurality of entities may include at least one of concepts, rules, clauses, and application attributes and relationships including at least one of cross-references, updates, expansions, and dependencies. Furthermore, the plurality of modules 202 may cause the processor 104 to generate a plurality of nodes in the graphical representation for the entities. Each node may include metadata. The metadata may include at least one of section titles, content summaries, and references. In addition, the plurality of modules 202 may cause the processor 104 to generate a plurality of edges between the plurality of nodes with edge types. The edge types may be selected from a conceptual-hierarchy type linking concepts and sub-concepts, a rule-clause type linking rules to clauses, the cross-referencing type linking text units, an updated-information type linking advice letters to rules, a referencing-updates type linking advice letters to referenced sections, and an additional-information type linking advice letters to subsequently added entities and rules. Further, the plurality of modules 202 may cause the processor 104 to perform a community detection on the plurality of nodes and the plurality of edges. The community detection may be performed using a Leiden clustering model to group the plurality of nodes into communities based on a relationship strength. Furthermore, the plurality of modules 202 may cause the processor 104 to generate community-level summaries in a sequential manner from leaf nodes. Each community-level summary may include key entities and relationships for a specific community. In addition, the plurality of modules 202 may cause the processor 104 to embed the entities into a graph vector space and the text units into a textual vector space using an embedding model. Further, the plurality of modules 202 may cause the processor 104 to query the graphical representation. The graphical representation may be queried using at least one of a global search mode on the community-level summaries, a local search mode on entity neighbors, and a drift search mode augmenting the local search mode with a community context. Furthermore, the plurality of modules 202 may cause the processor 104 to retrieve relevant nodes, edges, and summaries as the second candidate information.

In another example, in generating the third candidate information responsive to at least one of the user query and the one or more sub-queries based on the summaries of the rate structure documents and the regulatory documents, the plurality of modules 202 may cause the processor 104 to perform a keyword search on summaries of the rate structure documents and the regulatory documents. The keyword search may be performed using keywords extracted from at least one of the user query and the one or more sub-queries. The plurality of modules 202 may cause the processor 104 to retrieve matching summaries from a full-text search index based on at least one of term matches and phrase matches. Further, the plurality of modules 202 may cause the processor 104 to determine a text unit corresponding to each matching summary. Furthermore, the plurality of modules 202 may cause the processor 104 to output the determined text unit as the third candidate information.

In another example, in generating the refined context data by validating the consolidated context dataset and the interconnection-specific summary using the one or more Gen AI models 110, the plurality of modules 202 may cause the processor 104 to generate an initial context assessment. The initial context assessment may include an initial relevance score and an initial confidence score for each portion of the consolidated context dataset based on the user query and the interconnection-specific summary. The plurality of modules 202 may cause the processor 104 to identify specific-confidence portions of the consolidated context dataset. The specific-confidence portions may be identified based on the initial relevance score and the initial confidence score. Further, the plurality of modules 202 may cause the processor 104 to iteratively invoke at least one of the one or more Gen AI models 110 to re-rank the consolidated context dataset by assigning updated weights to the specific-confidence portions based on the initial context assessment. Furthermore, the plurality of modules 202 may cause the processor 104 to generate cross-references and alignments with the interconnection-specific summary using the one or more Gen AI models 110. In addition, the plurality of modules 202 may cause the processor 104 to validate the cross-references and the alignments. The cross-references and the alignments may be validated with regulatory standards and interconnection requirements encoded in the graphical representation. Further, the plurality of modules 202 may cause the processor 104 to combine the validated cross-references, and the alignments into the refined context data.

In another example, in determining the at least one interconnection-specific summary for the energy management system 112 based on the one or more interconnection attributes, the plurality of modules 202 may cause the processor 104 to receive the one or more interconnection attributes. The one or more interconnection attributes may include at least one of the project location, the capacity, the technology type, the voltage level, the point of interconnection, the selected rate structure option, and the application status. The plurality of modules 202 may cause the processor 104 to map the one or more interconnection attributes to corresponding eligibility criteria, compliance rules, and program requirements represented in the knowledge graph 124C. Further, the plurality of modules 202 may cause the processor 104 to traverse the plurality of nodes and the plurality of edges of the graphical representation to identify matching interconnection programs and the regulatory requirements associated with the one or more interconnection attributes. Furthermore, the plurality of modules 202 may cause the processor 104 to verify whether the one or more interconnection attributes satisfy conditions encoded in the matching interconnection programs and the regulatory requirements. In addition, the plurality of modules 202 may cause the processor 104 to identify at least one compliance issue based on the results of verification. The at least one compliance issue may include at least one of a missing site control, an invalid permit, a mismatched capacity, a mismatched voltage, and incorrect rate structure selection. Further, the plurality of modules 202 may cause the processor 104 to determine at least one required study based on the one or more interconnection attributes and the rate structure rules. The at least one required study may include at least one of a system impact study, a facilities study, and a transmission interconnection study. Furthermore, the plurality of modules 202 may cause the processor 104 to generate an eligibility determination indicating one or more eligible interconnection programs and associated rate structure options matching the one or more interconnection attributes. In addition, the plurality of modules 202 may cause the processor 104 to select at least one recommended interconnection program from the one or more eligible interconnection programs. The at least one recommended interconnection program may be selected from the one or more eligible interconnection programs based on at least one of historical approval rates and processing timelines associated with the one or more interconnection attributes. Further, the plurality of modules 202 may cause the processor 104 to compile the at least one compliance issue, the at least one required study, the eligibility determination, and the at least one recommended interconnection program into the at least one interconnection-specific summary.

In another example, in generating the Generative AI response to the user query based on the refined context data, the plurality of modules 202 may cause the processor 104 to generate an engineered prompt template including instructions to generate a structured response. The structured response may include the at least one recommendation, the at least one compliance instruction, and the at least one rate structure instruction. Further, the plurality of modules 202 may cause the processor 104 to generate a model-generated response for the user query using the one or more Generative Artificial Intelligence (AI) models 110 based on the generated engineered prompt template. Furthermore, the plurality of modules 202 may cause the processor 104 to map each specific portion of the model-generated response with at least one source identifier. The at least one source identifier may correspond to a specific page, section, table, and a document in the refined context data used to generate the specific portion. In addition, the plurality of modules 202 may cause the processor 104 to modify the model-generated response. The model-generated response may be modified to include at least one recommendation based on interconnection eligibility, the rate structure optimization, and the at least one compliance instruction. Further, the plurality of modules 202 may cause the processor 104 to output the modified model-generated response with the at least one source identifier.

In another example, the plurality of modules 202 may cause the processor 104 to generate page-wise images of the rate structure documents using an AI model. Further, the plurality of modules 202 may cause the processor 104 to extract a multi-modal content from the rate structure documents by processing the page-wise images. The multi-modal content may include text, tables, and figures of the energy management system 112. Furthermore, the plurality of modules 202 may cause the processor 104 to associate a set of page identifiers with corresponding extracted multi-modal content based on a type and a context of the multi-modal content.

In another example, the plurality of modules 202 may cause the processor 104 to pre-process the rate structure documents, the regulatory documents, and compliance documents by filtering noise, normalizing text, and segmenting documents into segments and contextual references. Further, the plurality of modules 202 may cause the processor 104 to generate at least one fine-tuned language model. The at least one fine-tuned language model may correspond to the user query by fine-tuning at least one base language model using pre-processed documents. Furthermore, the plurality of modules 202 may cause the processor 104 to generate a set of benchmark queries and reference responses. The set of benchmark queries and reference responses may be generated based on at least one of the rate structure documents and the regulatory documents. In addition, the plurality of modules 202 may cause the processor 104 to evaluate a performance of the at least one fine-tuned language model on a test dataset of regulatory queries and rate structure related queries using one or more accuracy metrics. The one or more accuracy metrics may include at least one of context-precision metrics, context-recall metrics, correctness metrics, faithfulness metrics, and relevancy metrics. Further, the plurality of modules 202 may cause the processor 104 to generate an overall performance score of the at least one fine-tuned language model based on results of the evaluation. Furthermore, the plurality of modules 202 may cause the processor 104 to refine at least one of training data coverage, retrieval parameters, prompt templates, training hyperparameters, and fine-tuned language model parameters based on the overall performance score.

In another example, the plurality of modules 202 may cause the processor 104 to assign a plurality of weights to the first candidate information, the second candidate information, and the third candidate information. Further, the plurality of modules 202 may cause the processor 104 to generate a first intermediate response and a second intermediate response. The first intermediate response and the second intermediate response may be generated to the user query based on a plurality of combinations of the plurality of weights. Furthermore, the plurality of modules 202 may cause the processor 104 to compute a confidence score for each of the first intermediate response and the second intermediate response. In addition, the plurality of modules 202 may cause the processor 104 to select one of the first intermediate response and the second intermediate response as part of the refined context data based on the confidence score.

In another example, the plurality of modules 202 may cause the processor 104 to assign a penalty to the Generative AI response determined to be incorrect. Further, the plurality of modules 202 may cause the processor 104 to assign a reward to the Generative AI response confirmed as correct by a human expert. Furthermore, the plurality of modules 202 may cause the processor 104 to adjust a response selection policy of the fine-tuned language model. The response selection policy of the fine-tuned language model may be adjusted based on the penalty and the reward.

In another example, the plurality of modules 202 may cause the processor 104 to establish connections among the plurality of AI agents 108. The plurality of AI agents 108 may include at least one of a tariff tracker agent, an eligibility assessment agent, an application review agent, and a customer support agent. Further, the plurality of modules 202 may cause the processor 104 to transmit structured intermediate results generated by a first AI agent as input constraints to a second AI agent. Furthermore, the plurality of modules 202 may cause the processor 104 to synchronize an execution of the plurality of AI agents 108. The execution of the plurality of AI agents 108 may be synchronized to execute a power grid interconnection workflow based on the structured intermediate results.

In another example, the plurality of modules 202 may cause the processor 104 to dynamically adjust a size of the consolidated context dataset. The size of the consolidated context dataset may be adjusted based on at least one of a complexity of the user query and a query nature.

In another example, the plurality of modules 202 may cause the processor 104 to update at least one of parameters of the fine-tuned language model and response selection policies. The at least one of parameters of the fine-tuned language model and response selection policies may be updated based at least in part on a user feedback data. Further, the plurality of modules 202 may cause the processor 104 to generate the plurality of Gen AI responses to subsequent queries determined to be similar to the user query by using the user feedback data as a preferred reference.

In some examples, the system 102 may perform temporal reasoning over the rate structure data documents by associating effective dates, supersession relationships, and dependency constraints with extracted document elements to provide a point in time determination of applicability, eligibility, and compliance. The system 102 may enforce cross-document consistency across rate structure data documents, enriched documents, and revised documents by identifying conflicting thresholds, mismatched definitions, and superseded provisions and resolving such conflicts using precedence rules encoded in the knowledge graph 124C. Further, the system 102 may perform multi-modal validation by jointly analyzing textual content, tabular data, graphical diagrams, and signature artifacts to verify compliance and flag application deficiencies. In addition, the system 102 may generate explainability artifacts identifying source documents, rule paths, thresholds, and temporal conditions to support auditability and regulatory transparency. Further, an execution of the system 102 may reduce response latency by tens of percent, reduce user escalation rates by approximately 50%, and improve answer completeness and accuracy by more than 20%.

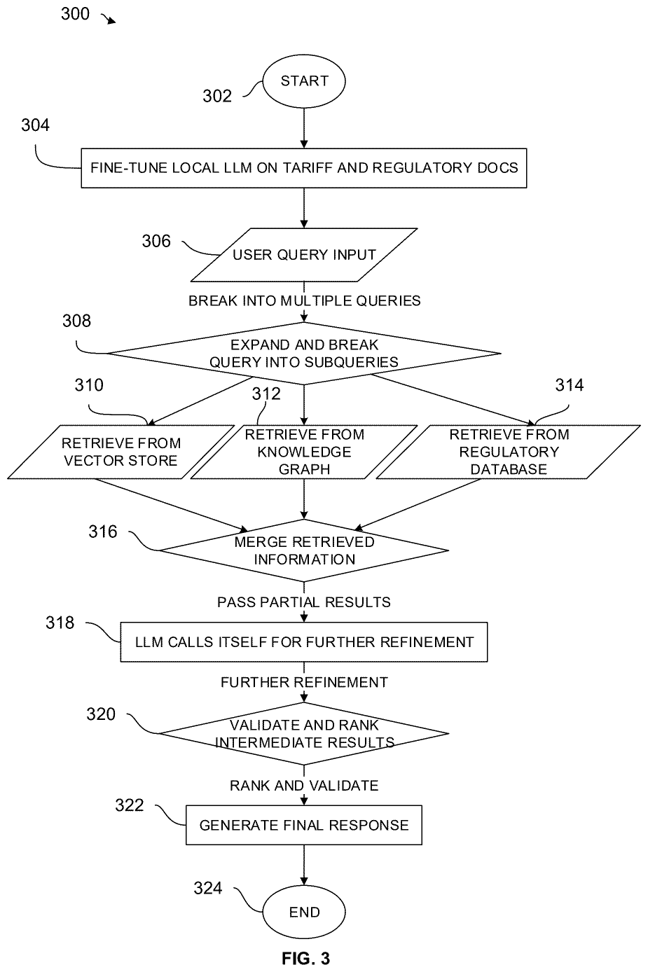

FIG. 3 illustrates an example flow diagram representation depicting an example method 300 for processing the user query related to the regulatory data and the power grid interconnections using the one or more Generative Artificial Intelligence (AI) models 110, according to an example. At step 302, the method 300 may include initiating execution of the system 102 configured to perform AI driven processing of user queries. The initiation may represent a starting point of a query resolution workflow implemented by a software architecture and one or more associated system components. At step 304, the method 300 may include fine tuning the one or more Gen AI models 110 such as, for example, but not limited to, a Large Language Model (LLM) and/or a Small Language Model (SLM), using rate structure data documents (interchangeably referred to as utility tariff documents), regulatory documents, and compliance documents. For example, the rate structure data documents, the regulatory document and the compliance documents may be stored in the centralized regulatory database 124A may act as a single source of truth for regulatory rules, tariff conditions, compliance requirements, legal amendments, and policy updates. The fine tuning of the one or more Gen AI models 110 may enhance a model understanding of complex energy regulations, rate structure data, and policy documents to improve accuracy of subsequent response generation. At step 306, the method 300 may include receiving a user query through a query interface, including a graphical user interface. In some examples, the user query may correspond to regulatory inquiries, tariff interpretation requests, compliance guidance, or interconnection related questions. When the user query may be complex or may require information from multiple data sources, the user query may be analyzed and parsed to identify constituent elements.

At step 308, the method 300 may include expanding and breaking the user query into one or more sub-queries by adding contextual details, ontology terms, or inferred attributes, such that each sub-query may represent a manageable and answerable portion of the original user query. The expansion may improve accuracy and completeness of subsequent retrieval operations. At step 310, the method 300 may include retrieving first candidate information from the vector store 124B by performing similarity based searches over vector embeddings generated from utility tariff documents, regulatory documents, and compliance related text. The vector store 124B may enable efficient contextual matching between the user query and/or the one or more sub-queries and semantically relevant document portions. At step 312, the method 300 may include retrieving second candidate information from the knowledge graph 124C that may represent entities, rules, conditions, and relationships among regulatory provisions, tariff structures, compliance obligations, and interconnection requirements. At step 314, the method 300 may include retrieving third candidate information from the centralized regulatory database 124A to obtain updated policy information, tariff revisions, regulatory amendments, and compliance requirements, thereby ensuring alignment with the most current regulatory data. At step 316, the method 300 may include merging information retrieved from the vector store 124B, the knowledge graph 124C, and the centralized regulatory database 124A to form a consolidated dataset responsive to the user query and the one or more sub-queries. The consolidated dataset may combine insights from multiple sources to provide a comprehensive informational basis. At step 318, the method 300 may include refining the consolidated dataset by recursively invoking one or more language models to improve result quality. Such refinement may include applying additional filtering, contextualization, re ranking, and validation operations. In some examples, ambiguous, incomplete, or irrelevant information may be corrected, modified, or removed. The refinement may further include validating retrieved information for alignment with regulatory standards and user requirements. At step 320, the method 300 may include ranking the refined results based on relevance to the user query and/or the one or more sub-queries and based on one or more confidence scores. In some examples, priority may be assigned to information determined to be more reliable, and a final validation may be performed. At step 322, the method 300 may include generating a structured response to the user query. The response may include recommendations, references to regulatory or tariff documents, and compliance instructions derived from the refined dataset. At step 324, the method 300 may conclude after outputting the structured response to the user.

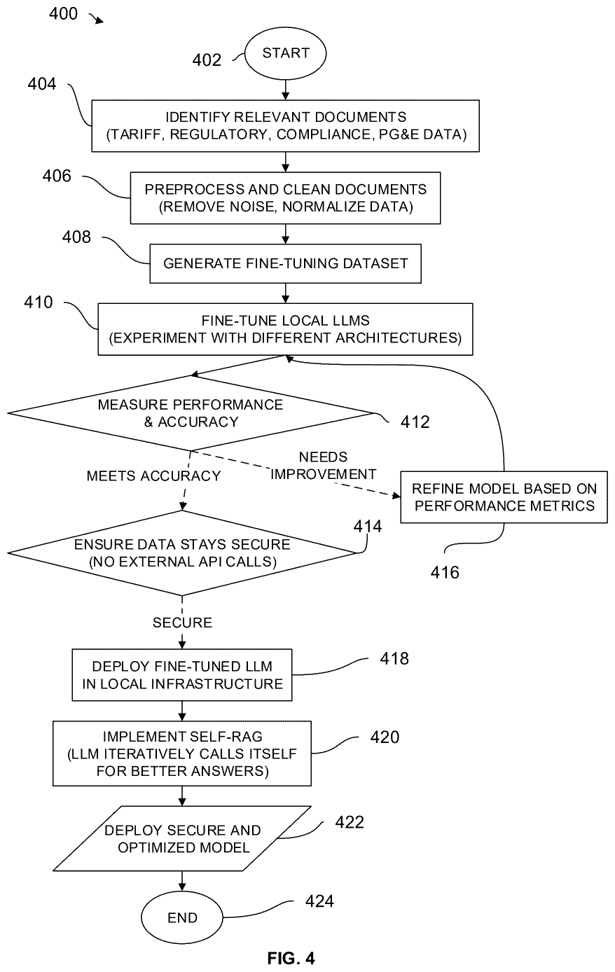

FIG. 4 illustrates an example flow diagram representation depicting an example method 400 for processing the user query related to the regulatory data and power grid interconnections using the one or more Generative Artificial Intelligence (AI) models 110, according to an example. At step 402, the method 400 may include initiating execution of a model fine tuning workflow. The initiation may represent an entry point for preparing one or more language models for domain specific processing.

At step 404, the method 400 may include identifying relevant documents for fine tuning the one or more language models. The identified documents may include rate structure data documents describing pricing rules and program conditions, regulatory documents comprising interconnection rules and policy requirements, and compliance documents specifying procedural and legal adherence requirements. In some examples, the regulatory documents may include utility specific rules, federal regulatory orders, and technical standards defining interconnection and operational requirements. At step 406, the method 400 may include preprocessing and cleaning the identified documents to improve data quality. Execution of step 406 may include removing noise comprising incomplete text, formatting artifacts, or irrelevant symbols, and normalizing textual content to standardize structure, terminology, and language conventions. In some examples, the preprocessing may ensure that the documents are structured and consistent for model training. At step 408, the method 400 may include generating a fine tuning dataset by transforming the cleaned documents into a structured dataset suitable for training the one or more language models. The fine tuning dataset may include segmented document content, regulatory references, contextual annotations, and metadata to support effective learning. At step 410, the method 400 may include fine tuning one or more large language models using the generated dataset. In an example, the one or more large language models may be referred to as the one or more Gen AI models 110. In some examples, the fine tuning may include experimenting with different model architectures, hyperparameters, and learning rates to improve performance and accuracy. At step 412, the method 400 may include measuring performance and accuracy of the fine-tuned language models. When the performance may not satisfy accuracy criteria or may require improvement, the method 400 may proceed to step 416. At step 416, the method 400 may include refining the one or more language models based on performance metrics. The refinement may include retraining with adjusted parameters, expanding the training dataset, improving coverage of complex or ambiguous queries, or discarding models that fail to meet accuracy thresholds. In some examples, the refined models may undergo repeated evaluation before further progression. When the performance satisfies accuracy requirements, the method 400 may proceed to step 414. The method 400 may include ensuring data security by confirming that no external application programming interface calls are performed during model execution. At step 418, the method 400 may include deploying the fine-tuned language model in a local infrastructure. The deployment may enable secure operation without reliance on external cloud services and/or third party Application Programming Interfaces (APIs). At step 420, the method 400 may include implementing self retrieval augmented generation. The language model may recursively invoke itself to improve answer quality through iterative refinement, contextual filtering, and reranking of generated responses. At step 422, the method 400 may include deploying a secure and optimized version of the language model for operational use. The deployment may support scalable and reliable handling of regulatory, rate structure, and compliance related queries. At step 424, the method 400 may conclude after successful deployment of the secure and optimized language model.

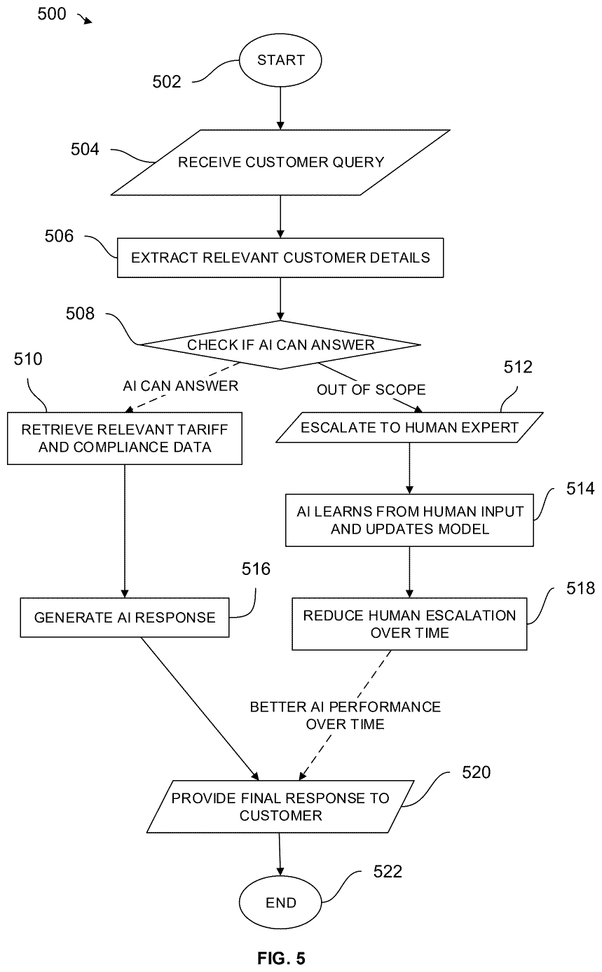

FIG. 5 illustrates an example flow diagram representation depicting an example method 500 for fine tuning, validating, and deploying the one or more Generative Artificial Intelligence (AI) models 110 for processing the regulatory data and rate structure documents to execute the user query, according to an example. At step 502, the method 500 may include initiating execution of a customer query handling workflow. The initiation may represent an entry point for processing customer queries when the system 102 may be activated and/or triggered. At step 504, the method 500 may include receiving a customer query through one or more communication channels, including a web portal, a mobile application, electronic mail, or a customer support chatbot. At step 506, the method 500 may include extracting relevant customer details from the received customer query. The extracted details may include a customer identifier for profile identification, a query type for classification, and contextual information comprising prior interactions, contractual data, or account status. At step 508, the method 500 may include determining whether one or more AI models may independently resolve the customer query based on an available knowledge base and learned capabilities of the AI models. When the customer query may be determined to be within the scope of the AI models, the method 500 may proceed to step 510. When the customer query may be determined to be outside the scope of the AI models, the method 500 may proceed to step 512. At step 510, the method 500 may include retrieving relevant rate structure data, regulatory data, and compliance data associated with the customer query. The retrieved data may include pricing models, rate plans, contractual conditions, regulatory standards, guidelines, and legal constraints applicable to the customer query. At step 512, the method 500 may include escalating the customer query to one or more human experts when the customer query exceeds the capabilities of the AI models or when uncertainty may be detected in the AI generated response. At step 514, the method 500 may include analyzing input received from the one or more human experts to extract insights for improving AI model performance. The insights may include modifications to the customer query, division of the customer query into one or more sub-queries, clarification of rate structure data, interpretation of regulatory provisions, or identification of compliance requirements. In some examples, the extracted insights may be used to update, augment, or retrain the AI models. At step 516, the method 500 may include generating an AI response to the customer query based on the retrieved rate structure data, regulatory data, compliance data, and any learned insights derived from prior human expert input. The generated response may be structured to address customer concerns and align with regulatory standards. At step 518, the method 500 may include reducing human escalation over time by enabling the AI models to learn from prior escalations, feedback signals, and historical human responses. In some examples, a feedback mechanism may be applied to penalize incorrect responses, reward correct responses, prioritize human provided answers, or store human responses as reference memory for handling similar future queries. At step 520, the method 500 may include providing a final response to the customer through the same communication channel by which the customer query was received. At step 522, the method 500 may conclude after the final response may be delivered to the customer, thereby completing a customer query resolution cycle. In some examples, the method 500 may further include query expansion by breaking the customer query into structured sub-queries, performing knowledge retrieval using vector search techniques and the knowledge graph 124C, and generating responses based on retrieved information. When uncertainty persists, the customer query and/or a sub-query may be escalated for human review. The AI models may refine future responses by learning from human feedback and historical interactions, thereby improving accuracy and effectiveness over time.

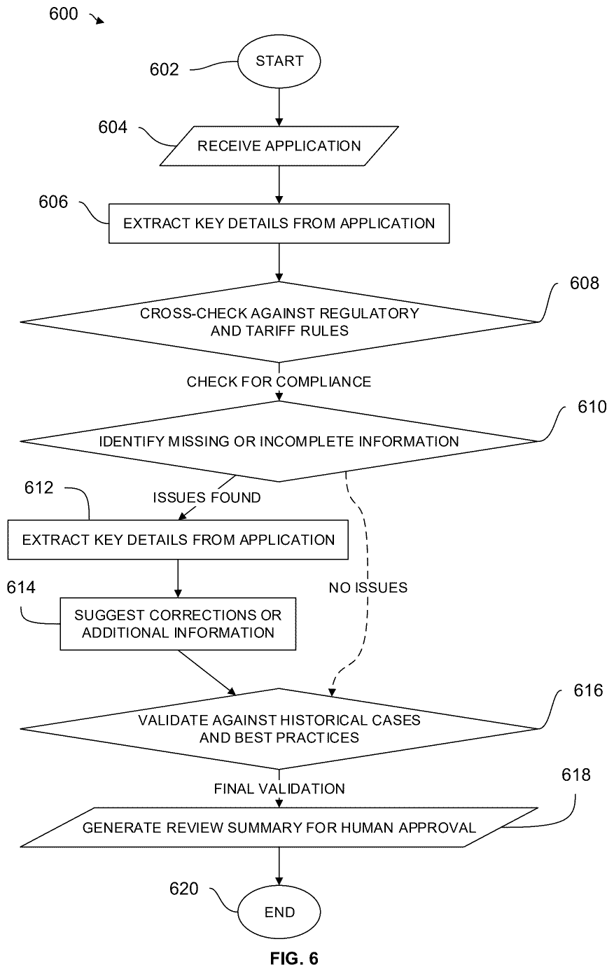

FIG. 6 illustrates an example flow diagram representation depicting an example method for processing the user query using the one or more Generative Artificial Intelligence (AI) models 110 with an application review agent, according to an example. At step 602, the method 600 may include initiating execution of an application review workflow when the system 102 may be activated or triggered, thereby marking a starting point for processing an application submission. At step 604, the method 600 may include receiving an application submitted for review through one or more submission channels, including an online portal, electronic mail, or an internal application management system. The received application may include applicant information, selected rate structure data, regulatory information, and supporting documentation. At step 606, the method 600 may include extracting key details from the received application. The extracted details may include applicant identification information, selected rate structure data, site plan information, single line diagram data, engineering studies, permit information, and compliance related information to support subsequent verification operations. At step 608, the method 600 may include crosschecking the extracted details against regulatory requirements and rate structure rules to determine alignment with applicable guidelines and to detect potential inconsistencies, errors, and/or violations. At step 610, the method 600 may include performing a compliance evaluation to determine whether the application satisfies one or more compliance requirements. The compliance evaluation may include verifying presence and validity of required data fields, confirming satisfaction of regulatory mandates, validating site control or exclusivity documentation, verifying building permits, confirming alignment of rate structure selections with legal frameworks, validating site plans and single line diagrams against utility requirements, and assessing validity of engineering studies. The method 600 may further include identifying missing or incomplete information, including incomplete applicant data, insufficient regulatory documentation, unspecified rate structure conditions, or invalid site documents. When compliance issues may be identified at step 610, the method 600 may proceed to step 612. The method 600 may include flagging potential compliance concerns and identifying portions of the application requiring correction or additional review. At step 614, the method 600 may include generating actionable recommendations to address the flagged compliance concerns. The recommendations may include instructions to submit missing documentation, correct regulatory inconsistencies, modify selected rate structure data, or revise application details to satisfy compliance requirements. When no compliance issues may be identified, or after corrective actions may be suggested, the method 600 may proceed to step 616. The method 600 may include validating the application against historical application data, prior use cases, and established best practices to perform a final validation. At step 618, the method 600 may include generating a review summary for human approval. The review summary may include verified application details, corrected information, compliance confirmation, identified issues, recommended corrective actions, and validation outcomes. At step 620, the method 600 may conclude after the application may be approved, rejected, and/or returned for further modification.

The method 600 may be executed by an application review Artificial Intelligence (AI) agent configured to extract application details from submitted documents and perform regulatory compliance validation using a self-assessment retrieval-augmented generation process. The application review AI agent may generate clarification requests when needed, produce a compliance report and approval checklist, escalate complex cases for human oversight, and improve accuracy through continuous learning from prior outcomes.

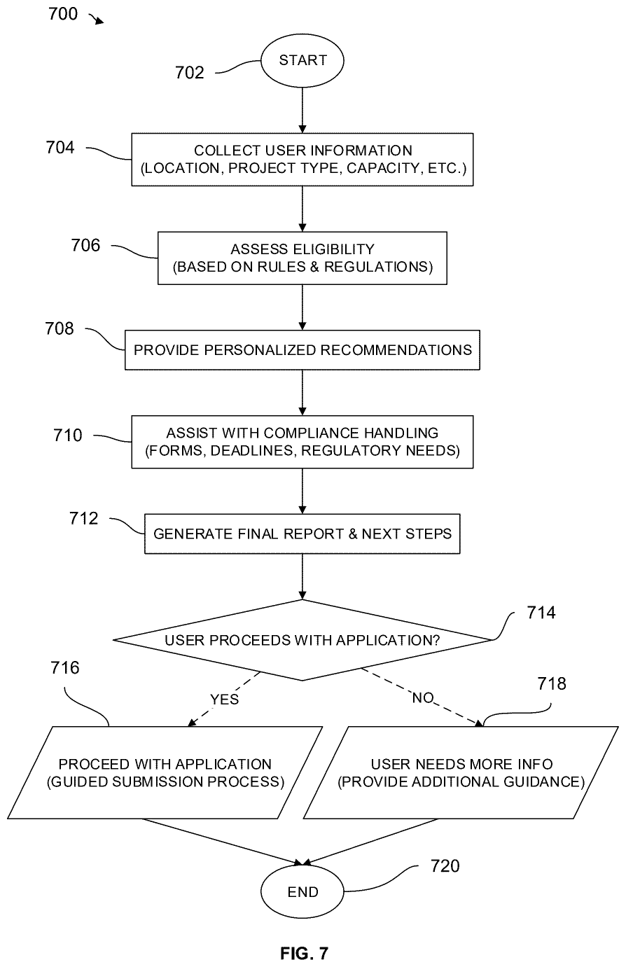

FIG. 7 illustrates an example flow diagram representation depicting an example method 700 for guiding a user through a power grid interconnection application submission process using the one or more Generative Artificial Intelligence (AI) models 110, according to an example. At step 702, the method 700 may include initiating an application guidance workflow. The initiation may occur in response to a system trigger and/or a user action indicating an intent to seek guidance for submitting an application. At step 704, the method 700 may include collecting user information to personalize the guidance process. The collected user information may include a project location, a project type, a project capacity, permit status, and a project scope to support eligibility evaluation and recommendation generation. At step 706, the method 700 may include assessing eligibility based on the collected user information. The eligibility assessment may be performed using applicable rules, regulations, and project feasibility criteria to determine compliance with legal, regulatory, and technical conditions. At step 708, the method 700 may include generating and providing personalized recommendations based on the eligibility assessment. The personalized recommendations may include suitable project configurations, applicable rate structure plans, and regulatory alignment steps intended to improve the likelihood of approval. At step 710, the method 700 may include assisting with compliance handling. The assistance may include providing guidance related to document submission requirements, regulatory deadlines, site plan preparation, single line diagram preparation, and applicable regulatory obligations to support adherence to compliance requirements. At step 712, the method 700 may include generating a final report summarizing eligibility results, personalized recommendations, compliance instructions, and next procedural steps for the user. At step 714, the method 700 may include determining whether the user intends to proceed with an application submission based on the generated report. When a determination may be made that the user may intend to proceed, the method 700 may proceed to step 716. The method 700 may include initiating a guided submission process. The guided submission process may include providing step by step instructions to support accurate application completion, address information gaps, and satisfy compliance requirements. When a determination may be made that the user may require additional information and/or the user may not prepared to proceed, the method 700 may proceed to step 718. The method 700 may include providing additional guidance related to eligibility criteria, regulatory steps, project configurations, and/or documentation requirements. The additional guidance may enable the user to revisit one or more prior steps of the method 700. At step 720, the method 700 may conclude when the user completes the application submission or receives sufficient guidance to proceed at a later time.

In some examples, the method 700 may be executed by an eligibility assessment Artificial Intelligence (AI) agent. The eligibility assessment AI agent may collect project related information from a user inquiry, map the collected information to eligibility criteria associated with one or more programs. The eligibility assessment AI agent may further provide detailed guidance regarding required documents, site plans, single line diagrams, permits, and applicable regulations.

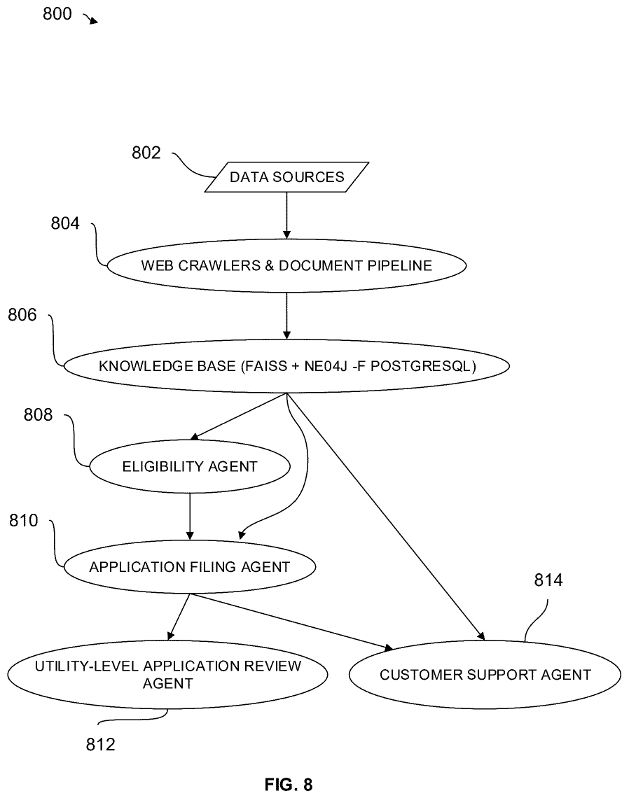

FIG. 8 illustrates an example flow diagram representation depicting an example method for processing at least one active and pending power grid interconnection application using the one or more Generative Artificial Intelligence (AI) models 110, according to an example, according to an example. At step 802, the method 800 may include gathering data from one or more data sources. The data sources may include rate structure data documents, regulatory rules, compliance requirements related to power generation, distribution, and usage, government databases, industry standards, technical documentation, and application records. At step 804, the method 800 may include extracting data using one or more web crawlers and processing the extracted data using a document pipeline. The one or more web crawlers may extract structured and unstructured data from web pages, regulatory websites, and technical databases. The document pipeline may organize, format, normalize, and filter the extracted data to support efficient storage and retrieval. At step 806, the method 800 may include storing the processed data in a knowledge base. The knowledge base may integrate one or more vector search systems for similarity search, a graph database management system for representing relationships among regulatory entities, a non relational document store for unstructured data, and a relational database management system for structured records with indexed access. At step 808, the method 800 may include invoking an eligibility agent. The eligibility agent may provide the knowledge base to assess user submitted applications by verifying eligibility criteria, cross referencing project attributes with stored guidelines, and generating eligibility related feedback for one or more downstream agents or users. At step 810, the method 800 may include invoking an application filing agent. The application filing agent may prepare utility level applications by auto populating forms, organizing supporting documents, validating formatting requirements, and ensuring alignment with regulatory and rate structure requirements prior to submission. At step 812, the method 800 may include invoking a utility level application review agent. The utility level application review agent may review filed applications to evaluate accuracy, completeness, and regulatory compliance before forwarding applications for further processing, approval, and/or escalation. At step 814, the method 800 may include invoking a customer support agent. The customer support agent may provide real time guidance to users, respond to queries related to eligibility determinations, submission errors, document requirements, and provide personalized assistance using insights derived from the knowledge base.

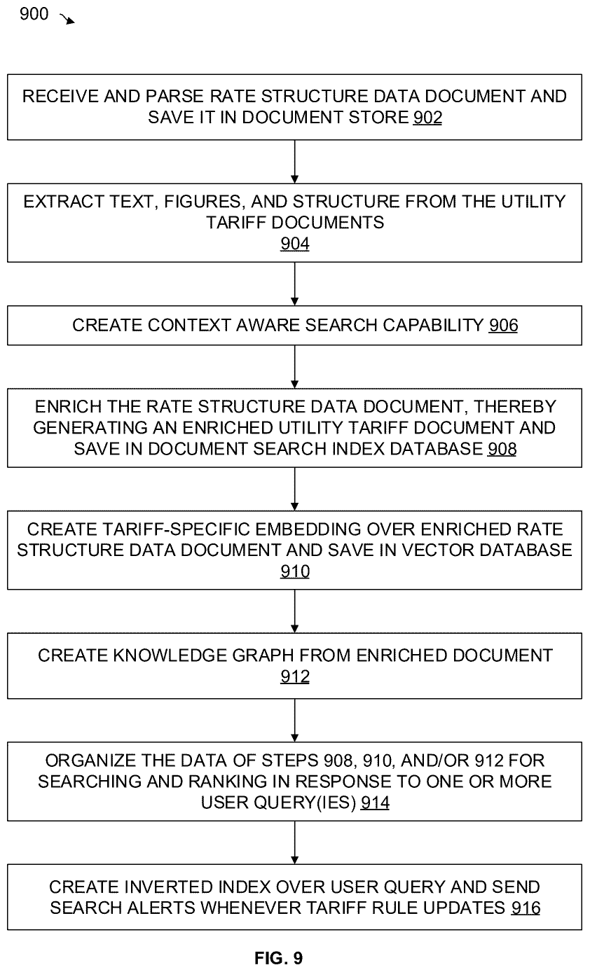

FIG. 9 illustrates an example flow diagram representation depicting an example method 900 for generating enriched portions of the regulatory documents and the rate structure documents for use in processing user queries, according to an example. At step 902, the method 900 may include receiving and parsing one or more rate structure data documents and optionally saving the one or more rate structure data documents in a document store. In some examples, the rate structure data documents may comprise one or more Portable Document Format (PDF) files including text, tables, figures, diagrams, and structured or semi structured formatting, such as tables of contents, headings, and cross references between sections. At step 904, the method 900 may include extracting text, tables, figures, and structural information from the rate structure data documents. In some examples, extraction may be performed page by page from one or more PDF documents. Additionally, or alternatively, tables may be extracted and saved in a structured format, including HyperText Markup Language (HTML) or plain text, to support structured data analysis. In some examples, page wise images of the rate structure data documents may be generated, encoded, and processed using the one or more Generative Artificial Intelligence (AI) models 110. Extracted content, including text, tables, figures, headings, section identifiers, and page numbers, may be stored in a structured representation, such as HTML, for further processing. Step 904 may be executed using one or more software applications, cloud computing platforms, and/or administrator devices. At step 906, the method 900 may include creating a context aware search capability over the extracted content. In some examples, execution of step 906 may include splitting extracted text into page wise files by inserting markers to identify the source location of content. Additionally, or alternatively, page identifiers may be associated with extracted tables, images, diagrams, and figures to preserve traceability to the original rate structure data documents. At step 908, the method 900 may include enriching the extracted content to generate an enriched rate structure data document. Enrichment may include adding ontology based terms related to interconnection programs, rate structures, and utility services, and performing content analysis and summarization using the one or more Generative Artificial Intelligence (AI) models 110. At step 910, the method 900 may include creating one or more embeddings over the enriched rate structure data document. The embeddings may be rate structure specific embeddings generated for individual content segments. At step 912, the method 900 may include creating the knowledge graph 124C from the enriched rate structure data document. The knowledge graph 124C may include nodes representing sections, tables, paragraphs, or figures of the rate structure data document. Each node may include metadata such as section titles, summaries, and references. Edges may be generated to represent relationships including direct references, updates or amendments, and dependencies between content elements. At step 914, the method 900 may include organizing the enriched rate structure data document, the vector embeddings, and the knowledge graph 124C for searching and ranking responses to one or more user queries. Indexing algorithms and data stores may be applied to match user queries with relevant enriched content across the document search index, the vector database 116, and the knowledge graph 124C. At step 916, the method 900 may include creating an inverted index over one or more user queries and generating search alerts when updates to rate structure rules are detected. In some examples, the search alerts may notify users and/or systems of changes impacting previously indexed or queried rate structure data.

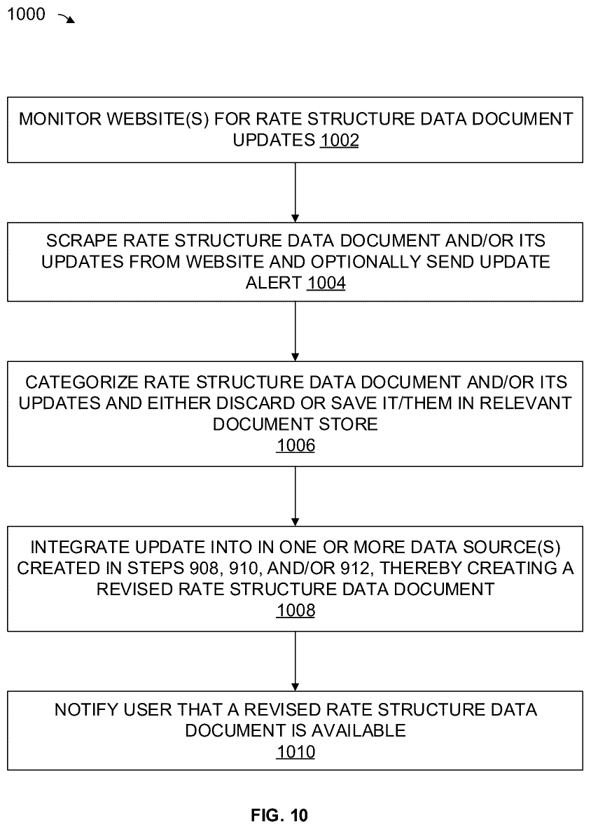

FIG. 10 illustrates an example flow diagram representation depicting an example method for updating enriched portions of the regulatory documents and the rate structure documents used for processing the user query, according to an example. At step 1002, the method 1000 may include monitoring one or more websites that host or provide rate structure data documents for updates, revisions, or additions. The monitoring may occur on a continuous basis, a periodic basis, and/or an as needed basis. Upon detection of an update or revision to a rate structure data document, the updated content may be identified for further processing. At step 1004, the method 1000 may include scraping, copying, or otherwise retrieving the rate structure data document update and/or revision from the monitored website. In some examples, execution of step 1004 may further include optionally transmitting an update alert to at least one user and/or an administrator indicating detection of the update. At step 1006, the method 1000 may include categorizing and classifying the rate structure data document update and/or revision based on relevancy, accuracy, and applicability to rate structure rules and related regulatory factors. In some examples, rate structure data document updates determined to be relevant and accurate may be saved in one or more relevant document stores, while rate structure data document updates determined to be not relevant and/or not accurate may be discarded and/or deleted. At step 1008, the method 1000 may include integrating the categorized updates and/or revisions into one or more data sources previously generated, including enriched rate structure data documents, document search index databases, vector databases, and/or knowledge graphs. Execution of step 1008 may thereby create a revised rate structure data document and/or a revised enriched rate structure data document with embeddings. At step 1010, the method 1000 may include notifying at least one user and/or administrator that a revised rate structure data document may be available. In some examples, execution of step 1010 may be responsive to user defined notification settings, which may be global or specific to one or more topics, programs, or search terms. The notification may be delivered in one or more formats including electronic mail, text alerts, webpage banners, and/or pop up notifications.

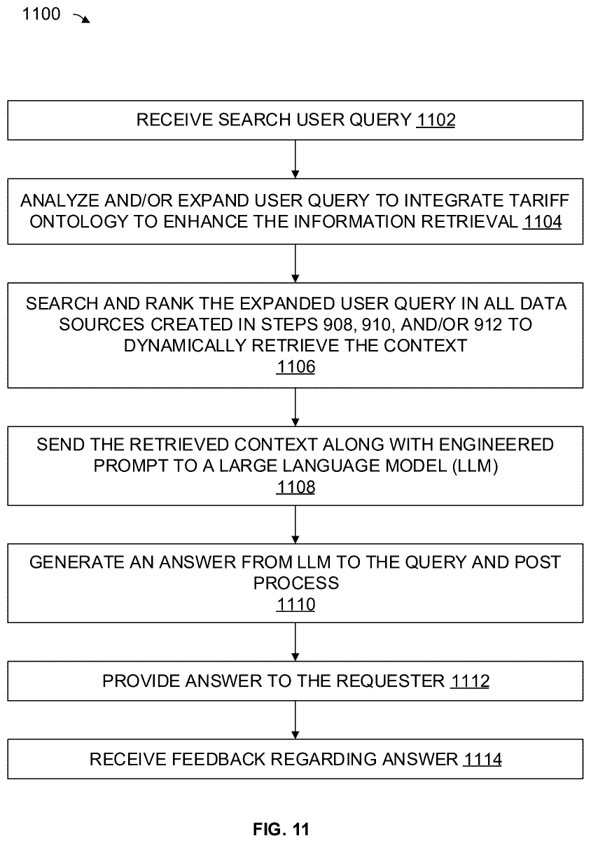

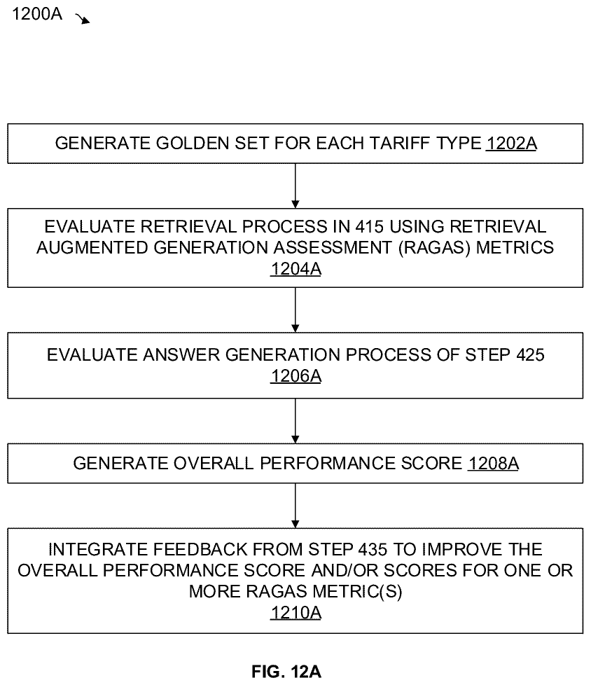

FIG. 11 illustrates an example flow diagram representation depicting an example method for processing the user query using the one or more Generative Artificial Intelligence (AI) model, according to an example. At step 1102, the method 1100 may include receiving a search user query from a requester, including at least one of a utility consumer, a utility provider, and/or a system administrator. The search user query may include a natural language query, one or more keywords, or a set of keywords. At step 1104, the method 1100 may include analyzing and/or expanding the received search user query using one or more Generative Artificial Intelligence models. Execution of step 1104 may include expanding the query with relevant ontology terms, weighted keywords, and related synonyms to enhance context matching. In some examples, execution of step 1104 may further include predicting a nature of the search user query, including whether the search user query corresponds to a detailed query or a summary query. At step 1106, the method 1100 may optionally include dynamically searching, retrieving, and ranking content from one or more data sources generated during execution of earlier processes, including enriched rate structure data documents, vector embeddings stored in the vector database 116, and entities and relationships stored in the knowledge graph 124C. Further, an execution of step 1106 may include retrieving relevant content units comprising text, figures, tables, document pages, and metadata. The retrieved context may be dynamically adjusted based on the predicted nature of the search user query. At step 1108, the method 1100 may include transmitting the retrieved context along with an engineered prompt to a Large Language Model (LLM). In some examples, execution of step 1108 may include formatting the engineered prompt to guide the LLM to generate a structured response aligned with regulatory and rate structure requirements. At step 1110, the method 1100 may include generating an answer to the search user query using the LLM based on the engineered prompt and the retrieved context. In some examples, the generated answer may be post processed to improve fidelity, relevance, and alignment with applicable regulatory standards and rate structure data. At step 1112, the method 1100 may include providing the generated answer to the requester. In some examples, execution of step 1112 may further include presenting one or more source identifiers associated with the answer, including page numbers, table identifiers, section identifiers, and/or document identifiers corresponding to the rate structure data documents and regulatory sources used to generate the answer. The answer may be displayed on a user interface, including a graphical user interface, together with references to the source documents. At step 1114, the method 1100 may include receiving feedback associated with the provided answer. In some examples, the received feedback may be stored and used to refine future query processing, retrieval ranking, prompt engineering, and response generation by one or more Generative Artificial Intelligence models.

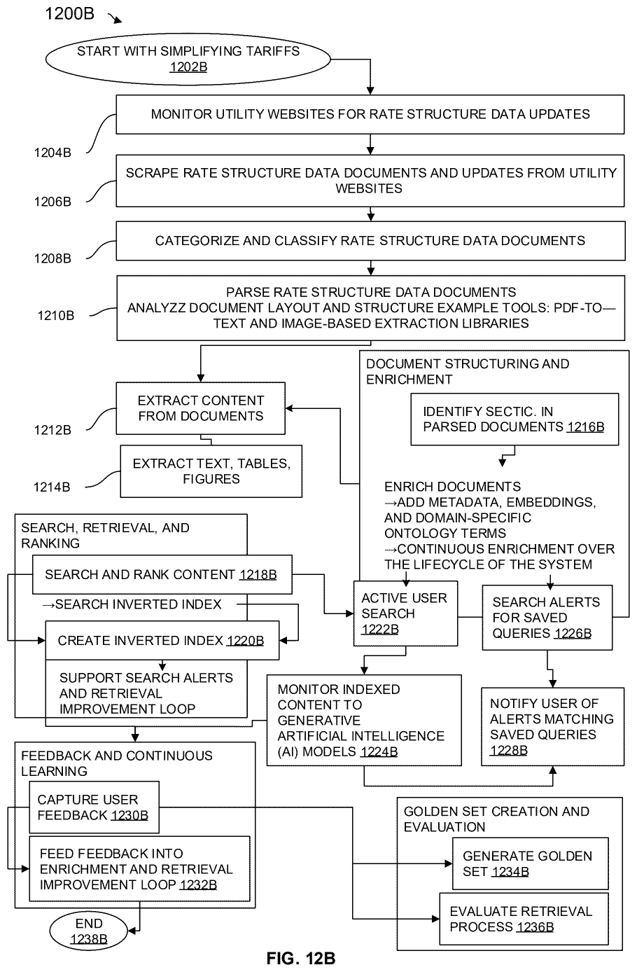

FIG. 12A illustrates an example flow diagram representation depicting an example method for evaluating performance of the one or more Generative Artificial Intelligence (AI) models 110, according to an example. The method 1200A may be executed by one or more systems and/or devices disclosed herein, including the system 102 and/or a component thereof. At step 1202A, the method 1200A may include generating a golden set for each rate structure data type. In some examples, the golden set may be generated using one or more rate structure data documents and/or rate structure data documents received from the rate structure data document host 132. The golden set may serve as a reference dataset for evaluating retrieval accuracy and answer quality. At step 1204A, the method 1200A may include evaluating a retrieval process used for responding to user queries. Execution of step 1204A may include assessing retrieval performance using one or more retrieval augmented generation assessment (RAGAS) metrics, including context precision, context recall, and other relevant retrieval metrics associated with retrieving contextual information from one or more data sources. At step 1206A, the method 1200A may include evaluating an answer generation process associated with generating responses to user queries. Execution of step 1206A may include assessing answer correctness, faithfulness, relevancy, and other answer quality metrics. In some examples, the evaluation may be personalized based on one or more user defined preferences and may be performed using one or more RAGAS metrics. At step 1208A, the method 1200A may include generating an overall performance score based on a combination of evaluation results obtained during execution of steps 1204A and 1206A. The overall performance score may be used to assess and improve fidelity and accuracy of context determination and answer generation processes. At step 1210A, the method 1200A may include integrating feedback obtained from prior user interactions and/or evaluation steps to improve the overall performance score and/or one or more individual RAGAS metric scores. In some examples, execution of step 1210A may include refining retrieval parameters, answer generation logic, or model configurations based on the integrated feedback. In some examples, execution of the method 1200A and one or more of steps 1202A, 1204A, 1206A, 1208A, and 1210A may be repeated on a periodic basis or an as needed basis to perform continuous quality checks and to maintain high accuracy and reliability of query responses.

FIG. 12B illustrates an example schematic diagram representation depicting a high level functional flow diagram of an example tariff tracker architecture 1200B, according to an example. The tariff tracker architecture 1200B may be configured to ingest the rate structure data documents and associated regulatory materials, process and normalize the ingested data, and perform tracking, analysis, and update detection operations. Further, the tariff tracker architecture 1200B may include one or more processing stages for document intake, enrichment, indexing, and evaluation, along with decision and feedback paths for identifying changes, determining relevance, and generating outputs such as alerts, summaries, or downstream actions. At step 1202B, the method 1200B may include initiating a tariff simplification workflow for processing the rate structure data documents. At step 1204B, the method 1200B may include monitoring the one or more utility websites to detect updates to the rate structure data documents. At step 1206B, the method 1200B may include scraping the rate structure data documents and associated updates from the one or more utility websites. In some examples, step 1206B may further include generating an alert when a new rate structure data document may be uploaded. At step 1208B, the method 1200B may include categorizing and classifying the rate structure data documents, including separating the rate structure data documents based on an applicability, a usage, and/or a customer type. At step 1210B, the method 1200B may include parsing the categorized rate structure data documents to analyze at least one of a document layout and a plurality of structural elements. In some examples, the parsing may include at least one of a Portable Document Format (PDF) to text extraction and an image based document processing. At step 1212B, the method 1200B may include extracting content from the parsed rate structure data documents. At step 1214B, the method 1200B may include extracting structured and unstructured content including at least one of text, tables, and figures from the rate structure data documents. At step 1216B, the method 1200B may include identifying sections within the parsed rate structure data documents and enriching the parsed rate structure data documents by adding metadata, embeddings, and domain-specific ontology terms. In some examples, an enrichment may occur continuously over a lifecycle of the system 102. At step 1218B, the method 1200B may include searching and ranking the enriched content in response to the user query. At step 1220B, the method 1200B may include creating an inverted index to support search, ranking, and alert generation, and to enable a retrieval improvement loop. At step 1222B, the method 1200B may include performing an active user search based on a received user query. At step 1224B, the method 1200B may include providing indexed and ranked content to the one or more Generative Artificial Intelligence (AI) models 110 for generating a response to the user query. At step 1226B, the method 1200B may include generating search alerts for one or more saved queries. In an example, the one or more saved queries may include the user query, which may be saved. At step 1228B, the method 1200B may include notifying the user when the search alerts may correspond to the one or more saved queries. At step 1230B, the method 1200B may include capturing user feedback associated with retrieved content and/or the generated responses. At step 1232B, the method 1200B may include feeding the captured user feedback into an enrichment and retrieval improvement process. At step 1234B, the method 1200B may include generating the golden set for evaluating a system performance. At step 1236B, the method 1200B may include evaluating retrieval performance using the golden set to improve accuracy and reliability. At step 1238B, the method 1200B may conclude.

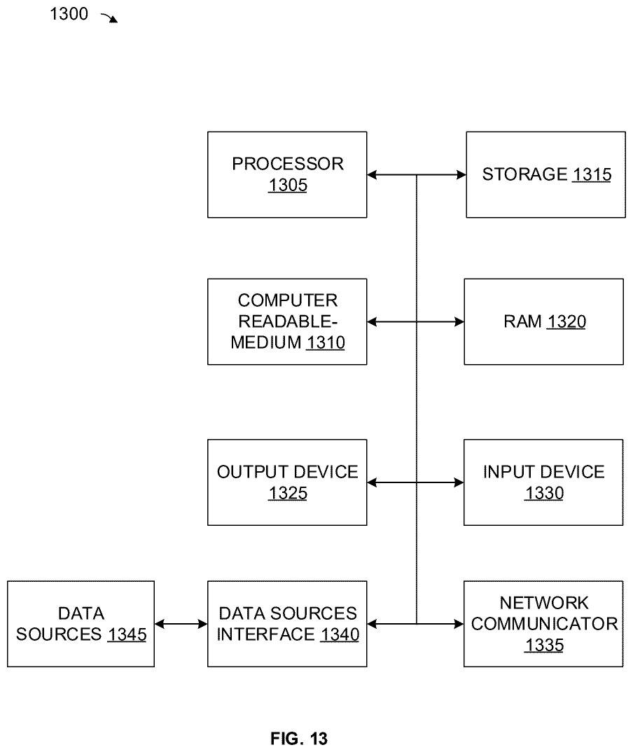

FIG. 13 illustrates an example block diagram representation of a hardware platform 1300 for implementation of a computer system, according to an example. The computer system may be part of or any one of the system 102, the energy management system 112 and the vector database 116, as shown in the network architecture 100A, to perform the functions and features described herein. Additionally, for the sake of brevity, construction, and operational features of the network architecture 100A which are explained in detail above are not explained in detail herein. Particularly, computing machines such as but not limited to internal/external server clusters, quantum computers, desktops, laptops, smartphones, tablets, and wearables which may be used to execute the network architecture 100A and/or may have the structure of the hardware platform 1300. As illustrated, the hardware platform 1300 may include additional components not shown, and that some of the components described may be removed and/or modified. For example, the computer system with multiple graphics processing unit (GPUs) may be located on external cloud platforms including web services, and/or internal corporate cloud computing clusters, or organizational computing resources, and the like.

Additionally, the hardware platform 1300 may be the computer system such as the network architecture 100A that may be used with the embodiments described herein. The computer system may represent a computational platform that includes components that may be in a server or another computer system. The computer system may execute, by a processor 1305, for example, a single and/or multiple processors, or other hardware processing circuit, the methods, functions, and other processes described herein. These methods, functions, and other processes may be embodied as machine readable instructions stored on a computer readable medium, which may be non transitory, such as hardware storage devices, for example, RAM (random access memory), ROM (read only memory), EPROM (erasable, programmable ROM), EEPROM (electrically erasable, programmable ROM), hard drives, and flash memory. The computer system may include the processor 1305 that executes software instructions or code stored on a computer readable storage medium 1310 to perform methods of the present disclosure.

Additionally, the instructions on the computer readable storage medium 1310 are read and stored the instructions in a storage 1315 and/or in random access memory (RAM). The storage 1315 may provide a space for keeping static data where at least some instructions could be stored for later execution. The stored instructions may be further compiled to generate other representations of the instructions and dynamically stored in the RAM such as RAM 1320. The processor 1305 may read instructions from the RAM 1320 and perform actions as instructed.

Additionally, the computer system may further include an output device 1325 to provide at least some of the results of the execution as output including, but not limited to, visual information to users, such as external agents. Further, the output device 1325 may include a display on computing devices. For example, the display may be a mobile phone screen or a laptop screen. Graphical user interfaces (GUIs) and/or text may be presented as an output on the display screen. The computer system may further include an input device 1330 to provide a user or another device with mechanisms for entering data and/or otherwise interact with the computer system. The input device 1330 may include, for example, a keyboard, a keypad, a mouse, or a touchscreen. Each of the output device 1325 and the input device 1330 may be joined by additional peripherals. For example, the output device 1325 may be used to display the results.

Additionally, a network communicator 1335 may be provided to connect the computer system to a network and in turn to other devices connected to the network including other clients, servers, data stores, and interfaces, for instance. Further, the network communicator 1335 may include, for example, a network adapter such as a LAN adapter or a wireless adapter. The computer system may include a data sources interface 1340 to access data sources 1345. The data sources 1345 may be an information resource. As an example, a database of exceptions and rules may be provided as the data sources 1345. Moreover, knowledge repositories and curated data may be other examples of the data source 1345.

FIG. 14 illustrates an example flow diagram representation of a method 1400 for processing regulatory data and power grid interconnections using the Generative Artificial Intelligence (AI) models 110, according to an example.

At block 1402, the method 1400 may include, receiving, by the one or more processors 104, a user query corresponding to the energy management system 112 from at least one user. The user query may correspond to at least one of a power grid process, a regulatory data, and a rate structure data.

At block 1404, the method 1400 may include, extracting, by the one or more processors 104, query data from the received user query. The query data may include at least one of a customer identifier, a query type, and contextual information corresponding to the user query.

At block 1406, the method 1400 may include, generating, by the one or more processors 104, one or more sub-queries based on the received user query and the extracted query data using the one or more Generative Artificial Intelligence (AI) models 110.

At block 1408, the method 1400 may include, obtaining, by the one or more processors 104, first candidate information responsive to at least one of the user query and the generated one or more sub-queries from the vector database 116. The vector database 116 may include regulatory documents and rate structure documents.

At block 1410, the method 1400 may include, generating, by the one or more processors 104, a graphical representation of the user query as second candidate information based on at least one of the user query and the one or more sub-queries using a graph-based AI model. The graphical representation may include entities and relationships between a plurality of rate structure rules, regulatory requirements, interconnection programs, and application attributes.

At block 1412, the method 1400 may include, generating, by the one or more processors 104, third candidate information responsive to at least one of the user query and the one or more sub-queries based on summaries of the rate structure documents and the regulatory documents. At block 1414, the method 1400 may include, aggregating, by the one or more processors 104, the first candidate information, the second candidate information, and the third candidate information into a consolidated context dataset.

At block 1416, the method 1400 may include, analyzing, by the one or more processors 104, the consolidated context dataset with one or more interconnection attributes associated with the user query. The one or more interconnection attributes may include at least one of a project location, a capacity, a technology type, a voltage level, a point of interconnection, a selected rate structure option, and an application status.

At block 1418, the method 1400 may include, determining, by the one or more processors 104, at least one interconnection-specific summary for the energy management system 112 based on the one or more interconnection attributes. The interconnection-specific summary may include at least one of an eligibility determination, a required study, a compliance issue, and a recommended interconnection program data.

At block 1420, the method 1400 may include, generating, by the one or more processors, a refined context data by validating the consolidated context dataset and the interconnection-specific summary using the one or more Generative AI models 110.

At block 1422, the method 1400 may include, generating, by the one or more processors 104, a Generative AI response to the user query based on the refined context data. The Generative AI response may include at least one recommendation, at least one compliance instruction and at least one rate structure instruction.

At block 1424, the method 1400 may include, outputting, by the one or more processors 104, the Generative AI response on a user interface of the user device 118.

In generating the one or more sub-queries based on the received user query and the extracted query data using the one or more Generative Artificial Intelligence (AI) models 110, the method 1400 may further include analyzing, by the one or more processors 104, the user query to identify at least one of keywords, ontology terms, and synonyms. The method 1400 may include predicting, by the one or more processors 104, a query nature comprising at least one of a detailed query and a summary query. Further, the method 1400 may include generating, by the one or more processors 104, the one or more sub-queries expanded with the ontology terms and weighted keywords based on the predicted query nature.

In obtaining the first candidate information responsive to the at least one of the user query and the generated one or more sub-queries from the vector database 116, the method 1400 may further include generating, by the one or more processors 104, a query vector representation for at least one of the user query and each of the one or more sub-queries using an embedding model. The method 1400 may further include performing, by the one or more processors 104, a similarity search in the vector database 116. The similarity search may be performed using the query vector representation to identify vector embeddings of enriched portions of the regulatory documents and the rate structure documents similar to the query vector representation. Further, the method 1400 may include computing, by the one or more processors 104, similarity scores. The similarity scores may be computed between the query vector representation and the identified vector embeddings using a similarity metric. Furthermore, the method 1400 may include selecting, by the one or more processors 104, a plurality of top-ranked vector embeddings based on the computed similarity scores. In addition, the method 1400 may include retrieving, by the one or more processors 104, the enriched portions. The enriched portions retrieved may correspond to the plurality of top-ranked vector embeddings from the vector database 116. Further, the method 1400 may include outputting, by the one or more processors 104, the enriched portions as the first candidate information.

In generating the graphical representation of the user query as the second candidate information based on at least one of the user query and the one or more sub-queries using the graph-based AI model, the method 1400 may include classifying, by the one or more processors 104, the regulatory documents and the rate structure documents into text units. Further, the method 1400 may include extracting, by the one or more processors 104, a plurality of entities from each text unit using the graph-based AI model. Furthermore, the method 1400 may include generating, by the one or more processors 104, a plurality of nodes in the graphical representation for the entities. In addition, the method 1400 may include generating, by the one or more processors 104, a plurality of edges between the plurality of nodes with edge types. The edge types may be selected from a conceptual-hierarchy type linking concepts and sub-concepts, a rule-clause type linking rules to clauses, a cross-referencing type linking text units, an updated-information type linking advice letters to rules, a referencing-updates type linking advice letters to referenced sections, and an additional-information type linking advice letters to subsequently added entities and rules. Further, the method 1400 may include performing, by the one or more processors 104, a community detection on the plurality of nodes and the plurality of edges. The community detection may be performed using a Leiden clustering model to group the plurality of nodes into communities based on a relationship strength. Furthermore, the method 1400 may include generating, by the one or more processors 104, community-level summaries in a sequential manner from leaf nodes. Each community-level summary may include key entities and relationships for a specific community. In addition, the method 1400 may include embedding, by the one or more processors 104, the entities into a graph vector space and the text units into a textual vector space using an embedding model. Further, the method 1400 may include querying, by the one or more processors 104, the graphical representation. The graphical representation may be queried using at least one of a global search mode on the community-level summaries, a local search mode on entity neighbors, and a drift search mode augmenting the local search mode with a community context. Furthermore, the method 1400 may include retrieving, by the one or more processors 104, relevant nodes, edges, and summaries as the second candidate information.

In generating the third candidate information responsive to at least one of the user query and the one or more sub-queries based on the summaries of the rate structure documents and the regulatory documents, the method 1400 may further include performing, by the one or more processors 104, a keyword search on summaries of the rate structure documents and the regulatory documents. The method 1400 may further include retrieving, by the one or more processors 104, matching summaries from a full-text search index based on at least one of term matches and phrase matches. Further, the method 1400 may further determining, by the one or more processors 104, a text unit corresponding to each matching summary. Furthermore, the method 1400 may further outputting, by the one or more processors 104, the determined text unit as the third candidate information.

In generating the refined context data by validating the consolidated context dataset and the interconnection-specific summary using the one or more Gen AI models 110, the method 1400 may further include generating, by the one or more processors 104, an initial context assessment. The method 1400 may include identifying, by the one or more processors 104, specific-confidence portions of the consolidated context dataset. The specific-confidence portions may be identified based on the initial relevance score and the initial confidence score. Further, the method 1400 may include iteratively invoking, by the one or more processors 104, at least one of the one or more Gen AI models 110 to re-rank the consolidated context dataset by assigning updated weights to the specific-confidence portions based on the initial context assessment. Furthermore, the method 1400 may include generating, by the one or more processors 104, cross-references and alignments with the interconnection-specific summary using the one or more Gen AI models 110. In addition, the method 1400 may include validating, by the one or more processors 104, the cross-references and the alignments. The cross-references and the alignments may be validated with regulatory standards and interconnection requirements encoded in the graphical representation. Further, the method 1400 may include combining, by the one or more processors 104, the validated cross-references, and the alignments into the refined context data.

In determining the at least one interconnection-specific summary for the energy management system 112 based on the one or more interconnection attributes, the method 1400 may include receiving, by the one or more processors 104, the one or more interconnection attributes. The method 1400 may include mapping, by the one or more processors 104, the one or more interconnection attributes to corresponding eligibility criteria, compliance rules, and program requirements represented in the knowledge graph 124C. Further, the method 1400 may include traversing, by the one or more processors 104, the plurality of nodes and the plurality of edges of the graphical representation to identify matching interconnection programs and the regulatory requirements associated with the one or more interconnection attributes. Furthermore, the method 1400 may include verifying, by the one or more processors 104, whether the one or more interconnection attributes satisfy conditions encoded in the matching interconnection programs and the regulatory requirements. In addition, the method 1400 may include identifying, by the one or more processors 104, at least one compliance issue based on the results of verification. Further, the method 1400 may include determining, by the one or more processors 104, at least one required study based on the one or more interconnection attributes and the rate structure rules. Furthermore, the method 1400 may include generating, by the one or more processors 104, an eligibility determination indicating one or more eligible interconnection programs and associated rate structure options matching the one or more interconnection attributes. In addition, the method 1400 may include selecting, by the one or more processors 104, at least one recommended interconnection program from the one or more eligible interconnection programs. The at least one recommended interconnection program may be selected from the one or more eligible interconnection programs based on at least one of historical approval rates and processing timelines associated with the one or more interconnection attributes. Further, the method 1400 may include compiling, by the one or more processors 104, the at least one compliance issue, the at least one required study, the eligibility determination, and the at least one recommended interconnection program into the at least one interconnection-specific summary.

In generating the Generative AI response to the user query based on the refined context data, the method 1400 may further include generating, by the one or more processors 104, an engineered prompt template including instructions to generate a structured response. Further, the method 1400 may include generating, by the one or more processors 104, a model-generated response for the user query using the one or more Generative Artificial Intelligence (AI) models 110 based on the generated engineered prompt template. Furthermore, the method 1400 may include mapping, by the one or more processors 104, each specific portion of the model-generated response with at least one source identifier. In addition, the method 1400 may include modifying, by the one or more processors 104, the model-generated response. The model-generated response may be modified to include at least one recommendation based on interconnection eligibility, the rate structure optimization, and the at least one compliance instruction. Further, the method 1400 may include outputting, by the one or more processors 104, the modified model-generated response with the at least one source identifier.

The method 1400 may further include generating, by the one or more processors 104, page-wise images of the rate structure documents using an AI model. Further, the method 1400 may include extracting, by the one or more processors 104, a multi-modal content from the rate structure documents by processing the page-wise images. Furthermore, the method 1400 may associating, by the one or more processors 104, a set of page identifiers with corresponding extracted multi-modal content based on a type and a context of the multi-modal content.

The method 1400 may further include pre-processing, by the one or more processors 104, the rate structure documents, the regulatory documents, and compliance documents by filtering noise, normalizing text, and segmenting documents into segments and contextual references. Further, the method 1400 may include generating, by the one or more processors 104, at least one fine-tuned language model. Furthermore, the method 1400 may include generating, by the one or more processors 104, a set of benchmark queries and reference responses. The set of benchmark queries and reference responses may be generated based on at least one of the rate structure documents and the regulatory documents. In addition, the method 1400 may include evaluating, by the one or more processors 104, a performance of the at least one fine-tuned language model on a test dataset of regulatory queries and rate structure related queries using one or more accuracy metrics. Further, the method 1400 may include generating, by the one or more processors 104, an overall performance score of the at least one fine-tuned language model based on results of the evaluation. Furthermore, the method 1400 may include refining, by the one or more processors 104, at least one of training data coverage, retrieval parameters, prompt templates, training hyperparameters, and fine-tuned language model parameters based on the overall performance score.

The method 1400 may further include assigning, by the one or more processors 104, a plurality of weights to the first candidate information, the second candidate information, and the third candidate information. Further, the method 1400 may include generating, by the one or more processors 104, a first intermediate response and a second intermediate response. The first intermediate response and the second intermediate response may be generated to the user query based on a plurality of combinations of the plurality of weights. Furthermore, the method 1400 may include computing, by the one or more processors 104, a confidence score for each of the first intermediate response and the second intermediate response. In addition, the method 1400 may include selecting, by the one or more processors 104, one of the first intermediate response and the second intermediate response as part of the refined context data based on the confidence score.

The method 1400 may further include detecting, by the one or more processors 104, an update to at least one rate structure rule and a regulatory requirement stored in the centralized regulatory database 124A. Further, the method 1400 may include determining, by the one or more processors 104, an impact of the detected update on at least one active and pending power grid interconnection application based on the interconnection-specific summaries. Furthermore, the method 1400 may include transmitting, by the one or more processors 104, an alert to at least one user associated with the at least one active and the pending power grid interconnection application. The alert may indicate the update and the impact on the interconnection application.

In generating the Generative AI response to the user query based on the refined context data, the method 1400 may further include receiving, by the one or more processors 104, project information associated with a power generation project of the energy management system 112 from the at least one user. Further, the method 1400 may include accessing, by the one or more processors 104, a knowledge base storing program eligibility criteria, rate structure plans, and compliance rules. The knowledge base storing program eligibility criteria, rate structure plans, and compliance rules may be based on the received project information. The knowledge base may include at least one of the knowledge graph 124C, the vector store 124B, and the centralized regulatory database 124A. Furthermore, the method 1400 may include determining, by the one or more processors 104, one or more interconnection programs and rate structure plans applicable to the project information. The one or more interconnection programs and the rate structure plans applicable to the project information may be determined by mapping the project information to eligibility criteria represented in the knowledge base. In addition, the method 1400 may include generating, by the one or more processors 104, eligibility results. Further, the method 1400 may include generating, by the one or more processors 104, the at least one recommendation based on the generated eligibility results. Furthermore, the method 1400 may include generating, by the one or more processors 104, a compliance guidance data for the power generation project based on the at least one recommendation. In addition, the method 1400 may include generating, by the one or more processors 104, a step-by-step guided submission workflow. The step-by-step guided submission workflow may be generated based on the eligibility results, the at least one recommendation and the compliance guidance data. Further, the method 1400 may include prompting, by the one or more processors 104, the at least one user for interconnection application data. The at least one user for interconnection application data may be prompted based on the step-by-step guided submission workflow in response to receiving an indication to proceed with submission from the at least one user. Furthermore, the method 1400 may include generating, by the one or more processors 104, one or more interconnection forms using the project information and the interconnection application data. In addition, the method 1400 may include transmitting, by the one or more processors 104, the one or more interconnection forms and associated documents for submission to a system operator. Further, the method 1400 may include generating, by the one or more processors 104, explainability information indicating at least one reason for an eligibility determination and an ineligibility determination. The explainability information may reference one or more specific rate structure rules and regulatory clauses applied. Furthermore, the method 1400 may include outputting, by the one or more processors 104, the explainability information with the eligibility results.

The method 1400 may further include receiving, by the one or more processors 104, the interconnection application data from the at least one user. the interconnection application data may include structured application data and a plurality of attached documents. Further, the method 1400 may include extracting, by the one or more processors 104, application details from the structured application data and the plurality of attached documents. Furthermore, the method 1400 may include accessing, by the one or more processors 104, regulatory rules and rate structure requirements from the centralized regulatory database 124A, the knowledge graph 124C, and the vector store 124B. In addition, the method 1400 may include determining, by the one or more processors 104, whether the interconnection application data satisfy a plurality of compliance checks based on the regulatory rules and the rate structure requirements. Further, the method 1400 may include generating, by the one or more processors 104, at least one recommendation indicating at least one corrective action to rectify at least one compliance issue. The at least one recommendation indicating at least one corrective action to rectify at least one compliance issue may be generated based on the at least one compliance issue detected. Furthermore, the method 1400 may include validating, by the one or more processors 104, the interconnection application data based on historical application data and the plurality of compliance checks being satisfied. In addition, the method 1400 may include generating, by the one or more processors 104, a review summary for the interconnection application data based on results of validation. The review summary may include at least one of verified application details, compliance confirmation, and the at least one corrective action.

The method 1400 may further include assigning, by the one or more processors 104, a penalty to the Generative AI response determined to be incorrect. Further, the method 1400 may include assigning, by the one or more processors 104, a reward to the Generative AI response confirmed as correct by a human expert. Furthermore, the method 1400 may include adjusting, by the one or more processors 104, a response selection policy of the fine-tuned language model. The response selection policy of the fine-tuned language model may be adjusted based on the penalty and the reward.

The method 1400 may further include establishing, by the one or more processors 104, connections among the plurality of AI agents 108. Further, the method 1400 may include transmitting, by the one or more processors 104, structured intermediate results generated by a first AI agent as input constraints to a second AI agent. Furthermore, the method 1400 may include synchronizing, by the one or more processors 104, an execution of the plurality of AI agents 108. The execution of the plurality of AI agents 108 may be synchronized to execute a power grid interconnection workflow based on the structured intermediate results.

The method 1400 may further include dynamically adjusting, by the one or more processors 104, a size of the consolidated context dataset. The size of the consolidated context dataset may be adjusted based on at least one of a complexity of the user query and a query nature.

The method 1400 may further include updating, by the one or more processors 104, at least one of parameters of the fine-tuned language model and response selection policies. The at least one of parameters of the fine-tuned language model and response selection policies may be updated based at least in part on a user feedback data. Further, the method 1400 may include generating, by the one or more processors 104, a plurality of Gen AI responses to subsequent queries determined to be similar to the user query by using the user feedback data as a preferred reference.

The order in which the method 1400 may be described may not be intended to be construed as a limitation, and any number of the described method blocks may be combined or otherwise performed in any order to implement the method 1400 or an alternate method. Additionally, individual blocks may be deleted from the method 1400 without departing from the spirit and scope of the ongoing description. Furthermore, the method 1400 may be implemented in any suitable hardware, software, firmware, or a combination thereof, that exists in the related art and/or that is later developed. The method 1400 describes, without limitation, the implementation of the system 102. A person of skill in the art will understand that method 1400 may be modified appropriately for implementation in various manners without departing from the scope and spirit of the ongoing description.

In an example, the systems and methods disclosed herein may implement a Retrieval Augmented Generation (RAG) processing workflow configured to generate context-aware responses to user queries based on regulatory data and rate structure data. The RAG workflow may employ one or more Generative Artificial Intelligence (AI) models, ontology-based enrichment, vector-based similarity search, and graph-based relationship modeling to extract, enrich, and organize source documents while preserving document structure, cross-references, and provenance. Extracted content may be segmented, summarized, embedded, and stored within a vector database and a knowledge graph to support similarity search, dependency analysis, and historical revision tracking. In response to a user query, the system may dynamically retrieve an adaptive context dataset using vector search, keyword search, and graph traversal, and generate a structured response with source references, thereby improving accuracy, relevance, and explainability of responses derived from regulatory and rate structure data.

Various examples herein provide Generative Artificial Intelligence (AI)-based methods and systems for processing regulatory data and power grid interconnections. The present disclosure may provide Thus, the present disclosure described herein may be used to assist utility customers, utility providers, and other energy stakeholders when navigating complex and frequently changing rate structure data documents and associated rate structure frameworks. For example, distribution level electricity rate structures may exhibit significant regional variation and frequent regulatory updates. The present disclosure may be used to simplify extraction of information from rate structure data documents by streamlining identification and retrieval of critical information contained within such documents. This streamlined extraction may improve efficiency when interpreting and utilizing rate structure data. The present disclosure may provide a user-friendly platform that enables personnel to efficiently access, understand, and remain current with rate structure data documents, thereby improving training, reducing errors, and promoting consistency in customer interactions. Additionally, the present disclosure may improve the efficiency and accuracy of rate structure analytics, modeling, and prediction for rate analysts, project developers, and other energy stakeholders. Accordingly, the disclosed systems, devices, and methods may provide an integrated technical framework for managing complex and dynamically changing rate structure data with improved accuracy, consistency, and operational efficiency. In some examples, the present disclosure may provide technical and practical advantages for managing, interpreting, and utilizing rate structure data documents, particularly distribution-level rate structures that exhibit regional variation and frequent regulatory updates. Accordingly, the present disclosure may provide a comprehensive technical solution that improves efficiency, accuracy, and regulatory alignment for utility providers, utility customers, analysts, and energy project stakeholders. The present disclosure may provide technical and practical advantages for managing and interpreting complex and frequently changing rate structure data documents, particularly distribution-level rate structures with significant regional variation and regulatory updates.

In some examples, performance of the systems disclosed herein may be evaluated using one or more quantitative performance metrics derived from one or more golden datasets. The golden datasets may include complex scenarios, corner cases, and representative query types including factual queries, applied regulatory scenarios, and multi-step reasoning queries. The system 102 may achieve accuracy, relevance, and answer faithfulness levels of at least ninety percent, with a target of exceeding approximately ninety-five percent through cyclic iteration. Performance evaluation may further incorporate text enrichment and prompt enrichment techniques to improve contextual understanding and response generation. The quantitative performance metrics may validate alignment of generated responses with regulatory intent, rate structure requirements, and source document content, thereby improving fidelity, relevance, and correctness. Strict response repeatability across separate user inquiries may not be required, as context-aware responses may adapt to variations in query phrasing, contextual data, temporal factors, and updated regulatory or rate structure data while maintaining substantive accuracy, relevance, and compliance.

One of ordinary skill in the art will appreciate that techniques consistent with the ongoing description are applicable in other contexts as well without departing from the scope of the ongoing description. As mentioned above, what is shown and described with respect to the systems and methods above are illustrative. While examples described herein are directed to configurations as shown, it should be appreciated that any of the components described or mentioned herein may be altered, changed, replaced, or modified, in size, shape, and numbers, or material, depending on application or use case, and adjusted for managing handoff. It should also be appreciated that the systems and methods, as described herein, may also include, or communicate with other components not shown. For example, these may include external processors, counters, analyzers, computing devices, and other measuring devices or systems. This may also include middleware (not shown) as well. The middleware may include software hosted by one or more servers or devices. Furthermore, it should be appreciated that some of the middleware or servers may or may not be needed to achieve functionality. Other types of servers, middleware, systems, platforms, and applications not shown may also be provided at the back end to facilitate the features and functionalities of the testing and measurement system.

Moreover, single components may be provided as multiple components, and vice versa, to perform the functions and features described herein. It should be appreciated that the components of the system described herein may operate in partial or full capacity, or it may be removed entirely. It should also be appreciated that analytics and processing techniques described herein with respect to the optical measurements, for example, may also be performed partially or in full by other various components of the overall system. It should be appreciated that data stores may also be provided to the apparatuses, systems, and methods described herein, and may include volatile and/or nonvolatile data storage that may store data and software or firmware including machine readable instructions. The software or firmware may include subroutines or applications that perform the functions of the measurement system and/or run one or more application that utilize data from the measurement or other communicatively coupled system.

What has been described and illustrated herein are examples of the implementation along with some variations. The terms, descriptions, and figures used herein are set forth by way of illustration only and are not meant as limitations. Many variations are possible within the scope of the implementations, which is intended to be defined by the following claims-and their equivalents in which all terms are meant in their broadest reasonable sense unless otherwise indicated.

1. A method for processing regulatory data and power grid interconnections using Generative Artificial Intelligence (AI) models, wherein the method comprises:
receiving, by one or more processors, a user query corresponding to an energy management system from at least one user, wherein the user query corresponds to at least one of a power grid process, a regulatory data, and a rate structure data;
extracting, by the one or more processors, query data from the received user query, wherein the query data comprises at least one of a customer identifier, a query type, and contextual information corresponding to the user query;
generating, by the one or more processors, one or more sub-queries based on the received user query and the extracted query data using one or more Generative Artificial Intelligence (AI) models;
obtaining, by the one or more processors, first candidate information responsive to at least one of the user query and the generated one or more sub-queries from a vector database, wherein the vector database comprises regulatory documents and rate structure documents;
generating, by the one or more processors, a graphical representation of the user query as second candidate information based on at least one of the user query and the one or more sub-queries using a graph-based AI model, wherein the graphical representation comprises entities and relationships between a plurality of rate structure rules, regulatory requirements, interconnection programs, and application attributes;
generating, by the one or more processors, third candidate information responsive to at least one of the user query and the one or more sub-queries based on summaries of the rate structure documents and the regulatory documents;
aggregating, by the one or more processors, the first candidate information, the second candidate information, and the third candidate information into a consolidated context dataset;
analyzing, by the one or more processors, the consolidated context dataset with one or more interconnection attributes associated with the user query, wherein the one or more interconnection attributes comprise at least one of a project location, a capacity, a technology type, a voltage level, a point of interconnection, a selected rate structure option, and an application status;
determining, by the one or more processors, at least one interconnection-specific summary for the energy management system based on the one or more interconnection attributes, wherein the interconnection-specific summary comprises at least one of an eligibility determination, a required study, a compliance issue, and a recommended interconnection program data;
generating, by the one or more processors, a refined context data by validating the consolidated context dataset and the interconnection-specific summary using the one or more Gen AI models;
generating, by the one or more processors, a Generative AI response to the user query based on the refined context data, wherein the Generative AI response comprises at least one recommendation, at least one compliance instruction and at least one rate structure instruction; and
outputting, by the one or more processors, the Generative AI response on a user interface of a user device.

2. The method of claim 1, wherein generating the one or more sub-queries based on the received user query and the extracted query data using one or more Generative Artificial Intelligence (AI) models comprises:
analyzing, by the one or more processors, the user query to identify at least one of keywords, ontology terms, and synonyms;
predicting, by the one or more processors, a query nature comprising at least one of a detailed query and a summary query; and
generating, by the one or more processors, the one or more sub-queries expanded with the ontology terms and weighted keywords based on the predicted query nature.

3. The method of claim 1, wherein obtaining the first candidate information responsive to the at least one of the user query and the generated one or more sub-queries from the vector database comprises:
generating, by the one or more processors, a query vector representation for at least one of the user query and each of the one or more sub-queries using an embedding model;
performing, by the one or more processors, a similarity search in the vector database using the query vector representation to identify vector embeddings of enriched portions of the regulatory documents and the rate structure documents similar to the query vector representation;
computing, by the one or more processors, similarity scores between the query vector representation and the identified vector embeddings using a similarity metric comprising a cosine similarity metric;
selecting, by the one or more processors, a plurality of top-ranked vector embeddings based on the computed similarity scores;
retrieving, by the one or more processors, the enriched portions corresponding to the plurality of top-ranked vector embeddings from the vector database; and
outputting, by the one or more processors, the enriched portions as the first candidate information.

4. The method of claim 1, wherein generating the graphical representation of the user query as the second candidate information based on at least one of the user query and the one or more sub-queries using the graph-based AI model comprises:
classifying, by the one or more processors, the regulatory documents and the rate structure documents into text units comprising at least one of paragraphs and sections;
extracting, by the one or more processors, a plurality of entities from each text unit using the graph-based AI model, wherein the plurality of entities comprise at least one of concepts, rules, clauses, and application attributes and relationships comprising at least one of cross-references, updates, expansions, and dependencies;
generating, by the one or more processors, a plurality of nodes in the graphical representation for the entities, wherein each node comprises metadata comprising at least one of section titles, content summaries, and references;
generating, by the one or more processors, a plurality of edges between the plurality of nodes with edge types selected from a conceptual-hierarchy type linking concepts and sub-concepts, a rule-clause type linking rules to clauses, a cross-referencing type linking text units, an updated-information type linking advice letters to rules, a referencing-updates type linking advice letters to referenced sections, and an additional-information type linking advice letters to subsequently added entities and rules;
performing, by the one or more processors, a community detection on the plurality of nodes and the plurality of edges using a Leiden clustering model to group the plurality of nodes into communities based on a relationship strength;
generating, by the one or more processors, community-level summaries in a sequential manner from leaf nodes, wherein each community-level summary comprises key entities and relationships for a specific community;
embedding, by the one or more processors, the entities into a graph vector space and the text units into a textual vector space using an embedding model;
querying, by the one or more processors, the graphical representation using at least one of a global search mode on the community-level summaries, a local search mode on entity neighbors, and a drift search mode augmenting the local search mode with a community context; and
retrieving, by the one or more processors, relevant nodes, edges, and summaries as the second candidate information.

5. The method of claim 1, wherein generating the third candidate information responsive to at least one of the user query and the one or more sub-queries based on the summaries of the rate structure documents and the regulatory documents comprise:
performing, by the one or more processors, a keyword search on summaries of the rate structure documents and the regulatory documents using keywords extracted from at least one of the user query and the one or more sub-queries;
retrieving, by the one or more processors, matching summaries from a full-text search index based on at least one of term matches and phrase matches;
determining, by the one or more processors, a text unit corresponding to each matching summary; and
outputting, by the one or more processors, the determined text unit as the third candidate information.

6. The method of claim 1, wherein generating the refined context data by validating the consolidated context dataset and the interconnection-specific summary using the one or more Gen AI models comprises:
generating, by the one or more processors, an initial context assessment comprising an initial relevance score and an initial confidence score for each portion of the consolidated context dataset based on the user query and the interconnection-specific summary;
identifying, by the one or more processors, specific-confidence portions of the consolidated context dataset based on the initial relevance score and the initial confidence score;
iteratively invoking, by the one or more processors, at least one of the one or more Gen AI models to re-rank the consolidated context dataset by assigning updated weights to the specific-confidence portions based on the initial context assessment;
generating, by the one or more processors, cross-references and alignments with the interconnection-specific summary using the one or more Gen AI models;
validating, by the one or more processors, the cross-references and the alignments with regulatory standards and interconnection requirements encoded in the graphical representation; and
combining, by the one or more processors, the validated cross-references, and the alignments into the refined context data.

7. The method of claim 1, wherein determining the at least one interconnection-specific summary for the energy management system based on the one or more interconnection attributes comprises:
receiving, by the one or more processors, the one or more interconnection attributes comprising at least one of the project location, the capacity, the technology type, the voltage level, the point of interconnection, the selected rate structure option, and the application status;
mapping, by the one or more processors, the one or more interconnection attributes to corresponding eligibility criteria, compliance rules, and program requirements represented in a knowledge graph;
traversing, by the one or more processors, the plurality of nodes and the plurality of edges of the graphical representation to identify matching interconnection programs and the regulatory requirements associated with the one or more interconnection attributes;
verifying, by the one or more processors, whether the one or more interconnection attributes satisfy conditions encoded in the matching interconnection programs and the regulatory requirements;
identifying, by the one or more processors, at least one compliance issue based on the results of verification, wherein the at least one compliance issue comprises at least one of a missing site control, an invalid permit, a mismatched capacity, a mismatched voltage, and incorrect rate structure selection;
determining, by the one or more processors, at least one required study based on the one or more interconnection attributes and the rate structure rules, wherein the at least one required study comprises at least one of a system impact study, a facilities study, and a transmission interconnection study;
generating, by the one or more processors, an eligibility determination indicating one or more eligible interconnection programs and associated rate structure options matching the one or more interconnection attributes;
selecting, by the one or more processors, at least one recommended interconnection program from the one or more eligible interconnection programs based on at least one of historical approval rates and processing timelines associated with the one or more interconnection attributes; and
compiling, by the one or more processors, the at least one compliance issue, the at least one required study, the eligibility determination, and the at least one recommended interconnection program into the at least one interconnection-specific summary.

8. The method of claim 1, wherein generating the Generative AI response to the user query based on the refined context data comprises:
generating, by the one or more processors, an engineered prompt template comprising instructions to generate a structured response, wherein the structured response comprises the at least one recommendation, the at least one compliance instruction, and the at least one rate structure instruction;
generating, by the one or more processors, a model-generated response for the user query using the one or more Generative Artificial Intelligence (AI) models based on the generated engineered prompt template;
mapping, by the one or more processors, each specific portion of the model-generated response with at least one source identifier corresponding to a specific page, section, table, and a document in the refined context data used to generate the specific portion;
modifying, by the one or more processors, the model-generated response to comprise at least one recommendation based on interconnection eligibility, the rate structure optimization, and the at least one compliance instruction; and
outputting, by the one or more processors, the modified model-generated response with the at least one source identifier.

9. The method of claim 1, further comprising:
generating, by the one or more processors, page-wise images of the rate structure documents using an AI model;
extracting, by the one or more processors, a multi-modal content from the rate structure documents by processing the page-wise images, wherein the multi-modal content comprises text, tables, and figures of the energy management system; and
associating, by the one or more processors, a set of page identifiers with corresponding extracted multi-modal content based on a type and a context of the multi-modal content.

10. The method of claim 1, further comprising:
pre-processing, by the one or more processors, the rate structure documents, the regulatory documents, and compliance documents by filtering noise, normalizing text, and segmenting documents into segments and contextual references;
generating, by the one or more processors, at least one fine-tuned language model corresponding to the user query by fine-tuning at least one base language model using pre-processed documents;
generating, by the one or more processors, a set of benchmark queries and reference responses based on at least one of the rate structure documents and the regulatory documents;
evaluating, by the one or more processors, a performance of the at least one fine-tuned language model on a test dataset of regulatory queries and rate structure related queries using one or more accuracy metrics, wherein the one or more accuracy metrics comprise at least one of context-precision metrics, context-recall metrics, correctness metrics, faithfulness metrics, and relevancy metrics;
generating, by the one or more processors, an overall performance score of the at least one fine-tuned language model based on results of the evaluation; and
refining, by the one or more processors, at least one of training data coverage, retrieval parameters, prompt templates, training hyperparameters, and fine-tuned language model parameters based on the overall performance score.

11. The method of claim 1, further comprising:
assigning, by the one or more processors, a plurality of weights to the first candidate information, the second candidate information, and the third candidate information;
generating, by the one or more processors, a first intermediate response and a second intermediate response to the user query based on a plurality of combinations of the plurality of weights;
computing, by the one or more processors, a confidence score for each of the first intermediate response and the second intermediate response; and
selecting, by the one or more processors, one of the first intermediate response and the second intermediate response as part of the refined context data based on the confidence score.

12. The method of claim 1, further comprising:
detecting, by the one or more processors, an update to at least one rate structure rule and a regulatory requirement stored in a centralized regulatory database;
determining, by the one or more processors, an impact of the detected update on at least one active and pending power grid interconnection application based on the interconnection-specific summaries; and
transmitting, by the one or more processors, an alert to at least one user associated with the at least one active and the pending power grid interconnection application, wherein the alert indicates the update and the impact on the interconnection application.

13. The method of claim 1, wherein generating the Generative AI response to the user query based on the refined context data comprises:
receiving, by one or more processors, project information associated with a power generation project of the energy management system from the at least one user, wherein the project information comprises at least one of a location, a capacity, a project type, and a point of interconnection;
accessing, by the one or more processors, a knowledge base storing program eligibility criteria, rate structure plans, and compliance rules based on the received project information, wherein the knowledge base comprises at least one of the knowledge graph, a vector store, and a centralized regulatory database;
determining, by the one or more processors, one or more interconnection programs and rate structure plans applicable to the project information by mapping the project information to eligibility criteria represented in the knowledge base;
generating, by the one or more processors, eligibility results comprising an indication of at least one eligible interconnection program and an associated rate structure plan;
generating, by the one or more processors, the at least one recommendation based on the generated eligibility results, wherein the at least one recommendation comprises at least one of a relevant project configuration, a required study, an applicable rate structure, and a regulatory alignment step;
generating, by the one or more processors, a compliance guidance data for the power generation project based on the at least one recommendation, wherein the compliance guidance data comprises at least one required document, a permit, a site plan, and a single-line diagram;
generating, by the one or more processors, a step-by-step guided submission workflow based on the eligibility results, the at least one recommendation and the compliance guidance data;
prompting, by the one or more processors, the at least one user for interconnection application data based on the step-by-step guided submission workflow in response to receiving an indication to proceed with submission from the at least one user;
generating, by the one or more processors, one or more interconnection forms using the project information and the interconnection application data;
transmitting, by the one or more processors, the one or more interconnection forms and associated documents for submission to a system operator;
generating, by the one or more processors, explainability information indicating at least one reason for an eligibility determination and an ineligibility determination, wherein the explainability information references one or more specific rate structure rules and regulatory clauses applied; and
outputting, by the one or more processors, the explainability information with the eligibility results.

14. The method of claim 12, further comprising:
receiving, by the one or more processors, the interconnection application data from the at least one user, wherein the interconnection application data comprises structured application data and a plurality of attached documents;
extracting, by the one or more processors, application details from the structured application data and the plurality of attached documents, wherein the application details comprise at least one of applicant information, a rate-structure selection, a site control information, permit information, engineering studies, site plans, and single-line diagrams;
accessing, by the one or more processors, regulatory rules and rate structure requirements from a centralized regulatory database, the knowledge graph, and a vector store;
determining, by the one or more processors, whether the interconnection application data satisfy a plurality of compliance checks based on the regulatory rules and the rate structure requirements;
generating, by the one or more processors, at least one recommendation indicating at least one corrective action to rectify at least one compliance issue based on the at least one compliance issue detected;
validating, by the one or more processors, the interconnection application data based on historical application data and the plurality of compliance checks being satisfied; and
generating, by the one or more processors, a review summary for the interconnection application data based on results of validation, wherein the review summary comprises at least one of verified application details, compliance confirmation, and the at least one corrective action.

15. The method of claim 1, further comprising:
assigning, by the one or more processors, a penalty to the Generative AI response determined to be incorrect;
assigning, by the one or more processors, a reward to the Generative AI response confirmed as correct by a human expert; and
adjusting, by the one or more processors, a response selection policy of the fine-tuned language model based on the penalty and the reward.

16. The method of claim 1, further comprising:
establishing, by the one or more processors, connections among a plurality of AI agents comprising at least one of a tariff tracker agent, an eligibility assessment agent, an application review agent, and a customer support agent;
transmitting, by the one or more processors, structured intermediate results generated by a first AI agent as input constraints to a second AI agent; and
synchronizing, by the one or more processors, an execution of the plurality of AI agents to execute a power grid interconnection workflow based on the structured intermediate results.

17. The method of claim 1, further comprising:
dynamically adjusting, by the one or more processors, a size of the consolidated context dataset based on at least one of a complexity of the user query and a query nature.

18. The method of claim 1, further comprising:
updating, by the one or more processors, at least one of parameters of the fine-tuned language model and response selection policies based at least in part on a user feedback data; and
generating, by the one or more processors, a plurality of Generative Artificial Intelligence (Gen AI) responses to subsequent queries determined to be similar to the user query by using the feedback data as a preferred reference.

19. A system for processing regulatory data and power grid interconnections using Generative Artificial Intelligence (AI) models, the system comprising:
a processor; and
a memory communicably coupled to the processor, wherein the memory comprises processor-executable instructions which, when executed by the processor, cause the processor to:
receive a user query corresponding to an energy management system from at least one user, wherein the user query corresponds to at least one of a power grid process, a regulatory data, and a rate structure data;
extract a query data from the received user query, wherein the query data comprises at least one of a customer identifier, a query type, and contextual information corresponding to the user query;
generate one or more sub-queries based on the received user query and the extracted query data using one or more Generative Artificial Intelligence (AI) models;
obtain first candidate information responsive to at least one of the user query and the generated one or more sub-queries from a vector database, wherein the vector database comprises regulatory documents and rate structure documents;
generate a graphical representation of the user query as second candidate information based on at least one of the user query and the one or more sub-queries using a graph-based AI model, wherein the graphical representation comprises entities and relationships between a plurality of rate structure rules, regulatory requirements, interconnection programs, and application attributes;
generate third candidate information responsive to at least one of the user query and the one or more sub-queries based on summaries of the rate structure documents and the regulatory documents;
aggregate the first candidate information, the second candidate information, and the third candidate information into a consolidated context dataset;
analyze the consolidated context dataset with one or more interconnection attributes associated with the user query, wherein the one or more interconnection attributes comprise at least one of a project location, a capacity, a technology type, a voltage level, a point of interconnection, a selected rate structure option, and an application status;
determine at least one interconnection-specific summary for the energy management system based on the one or more interconnection attributes, wherein the interconnection-specific summary comprises at least one of an eligibility determination, a required study, a compliance issue, and a recommended interconnection program data;
generate a refined context data by validating the consolidated context dataset and the interconnection-specific summary using the one or more Gen AI models;
generate a Generative AI response to the user query based on the refined context data, wherein the Generative AI response comprises at least one recommendation, at least one compliance instruction and at least one rate structure instruction; and
output the Generative AI response on a user interface of a user device.

20. A non-transitory computer readable medium comprising a processor executable instruction that cause a processor to:
receive a user query corresponding to an energy management system from at least one user, wherein the user query corresponds to at least one of a power grid process, a regulatory data, and a rate structure data;
extract a query data from the received user query, wherein the query data comprises at least one of a customer identifier, a query type, and contextual information corresponding to the user query;
generate one or more sub-queries based on the received user query and the extracted query data using one or more Generative Artificial Intelligence (AI) models;
obtain first candidate information responsive to at least one of the user query and the generated one or more sub-queries from a vector database, wherein the vector database comprises regulatory documents and rate structure documents;
generate a graphical representation of the user query as second candidate information based on at least one of the user query and the one or more sub-queries using a graph-based AI model, wherein the graphical representation comprises entities and relationships between a plurality of rate structure rules, regulatory requirements, interconnection programs, and application attributes;
generate third candidate information responsive to at least one of the user query and the one or more sub-queries based on summaries of the rate structure documents and the regulatory documents;
aggregate the first candidate information, the second candidate information, and the third candidate information into a consolidated context dataset;
analyze the consolidated context dataset with one or more interconnection attributes associated with the user query, wherein the one or more interconnection attributes comprise at least one of a project location, a capacity, a technology type, a voltage level, a point of interconnection, a selected rate structure option, and an application status;
determine at least one interconnection-specific summary for the energy management system based on the one or more interconnection attributes, wherein the interconnection-specific summary comprises at least one of an eligibility determination, a required study, a compliance issue, and a recommended interconnection program data;
generate a refined context data by validating the consolidated context dataset and the interconnection-specific summary using the one or more Gen AI models;
generate a Generative AI response to the user query based on the refined context data, wherein the Generative AI response comprises at least one recommendation, at least one compliance instruction and at least one rate structure instruction; and
output the Generative AI response on a user interface of a user device.
